(19) United States
(12) Patent Application Publication
(10) Pub. No.: US 2026/0156680 A1
(43) Pub. Date: Jun. 4, 2026

(54) SENSING METHOD AND COMMUNICATION APPARATUS

(71) Applicant: HUAWEI TECHNOLOGIES CO., LTD., Shenzhen (CN)

(72) Inventors: Wenyue Zhang, Chengdu (CN); Xuming Fang, Chengdu (CN); Gaoyong Huang, Chengdu (CN); Rui Du, Singapore (SG)

(21) Appl. No.: 19/461,915

(22) Filed: Jan. 28, 2026

Related U.S. Application Data
(63) Continuation of application No. PCT/CN2024/105897, filed on Jul. 17, 2024.

(30) Foreign Application Priority Data
Jul. 29, 2023 (CN) 202310952356.4

(51) Int. Cl. H04W 74/0816; H04L 5/00; H04W 24/10; H04W 74/06

(52) U.S. Cl. CPC H04W 74/0816; H04L 5/0053; H04W 24/10; H04W 74/06

(57) ABSTRACT

A processing apparatus includes a processor. The processing apparatus is a first access point (AP). When the processor executes a computer program stored in a memory, the processing apparatus is caused to: separately send, to N access points (APs), first request frames corresponding to the N APs. The first request frames are used by the N APs to initiate a multi-AP joint sensing by proxy request, and N is a positive integer. The processing apparatus is also caused to separately receive, from the N APs, first response frames corresponding to the N APs. The first response frames indicate the multi-AP joint sensing by proxy request is accepted.

### CROSS-REFERENCE TO RELATED APPLICATIONS

This application is a continuation of International Application No. PCT/CN2024/105897, filed on Jul. 17, 2024, which claims priority to Chinese Patent Application No. 202310952356.4, filed on Jul. 29, 2023. The disclosures of the aforementioned applications are hereby incorporated by reference in their entireties.

### TECHNICAL FIELD

This application relates to the field of wireless communication, and specifically, to a sensing method and a communication apparatus.

### BACKGROUND

When sensing a target in an overlapping basic service set (OBSS), an access point (AP) may be subject to interference from another device in space, for example, co-channel or adjacent-channel interference, and have poor sensing performance because the sensed target is on an edge of a basic service set (BSS). As a result, a measurement result has a large error. However, in a time window used for sensing measurement, the AP keeps performing sensing measurement as long as a communication link is not interrupted. The AP can learn, only after obtaining a sensing measurement report and performing signal processing according to a specific algorithm, that the sensing measurement result has a large error, and has to discard the measurement result, resulting in a sensing task failure. Therefore, the AP may request a plurality of other APs to perform sensing measurement on behalf of the AP, that is, the plurality of APs perform joint sensing. When a sensing result of an AP is unavailable, a sensing result of another AP may be used.

However, current sensing by proxy (SBP) allows only a non-access point station (AP STA) to request an AP to perform a sensing measurement process on behalf of the non-AP STA. To be specific, existing SBP can be initiated only by a STA, and does not support an AP in requesting an AP to perform sensing by proxy. Consequently, a multi-AP joint sensing by proxy solution cannot be implemented based on current SBP.

### SUMMARY

This application provides a sensing method and a communication apparatus, to avoid a sensing task failure caused by sensing result unavailability when an AP performs sensing alone.

According to a first aspect, a sensing method is provided. The method may be performed by a communication device, or may be performed by a component (for example, a chip or a circuit) of the communication device. This is not limited. For ease of description, the following uses an example in which the method is performed by a first AP for description.

The method includes: The first AP separately sends, to N APs, first request frames corresponding to the N APs, where the first request frame is used by an AP to initiate a multi-AP joint sensing by proxy request, and N is a positive integer; and the first AP separately receives first response frames from the N APs, where the first response frame indicates that the multi-AP joint sensing by proxy request is accepted.

In the foregoing technical solution, the first AP can send the first request frames to the N APs to request one or more APs to perform joint sensing. The method enables the first AP to use a sensing result of the one or more APs, thereby avoiding a sensing task failure caused by sensing result unavailability when the first AP performs sensing alone.

It should be noted that, in this solution, multi-AP joint sensing by proxy may be joint sensing performed by a plurality of APs on a same target; or multi-AP joint sensing by proxy may be sensing respectively performed on different parts of the same target, where the first AP may obtain a sensing result of the entire target based on sensing results of different APs; or multi-AP joint sensing by proxy may be joint sensing performed on an environment. A sensed target of multi-AP joint sensing is not specifically limited in this application.

In some implementations of the first aspect, the first request frame includes first information. The first information indicates that the first request frame is a request frame used by an AP to initiate multi-AP joint sensing by proxy. The first information is carried in a public action/protected dual of public action Public Action/Protected Dual of Public Action field included in the first request frame.

It may be understood that, in this technical solution, a device that receives the first request frame may determine, based on the first information in the first request frame, that a device type of a device that initiates the multi-AP joint sensing by proxy request is an AP.

In some implementations of the first aspect, the first request frame includes second information. The second information includes a parameter required for a second AP to perform multi-AP joint sensing by proxy. The second AP is an AP that receives the first request frame.

In some implementations of the first aspect, the parameter required for the second AP to perform multi-AP joint sensing by proxy includes one or more of the following parameters: a multi-AP joint sensing expiration time, a multi-AP coordinated transmission model, a trigger-based sounding phase model, a number of required sensing responder STA sensing responder stations STAs, and whether the number of sensing responder STAs is mandatory.

In some implementations of the first aspect, the first response frame includes third information. The third information indicates that the first response frame is a response frame responding to a multi-AP joint sensing by proxy request initiated by an AP. The third information is carried in a public action/protected dual of public action Public Action/Protected Dual of Public Action field included in the first response frame.

In some implementations of the first aspect, the method further includes: The first AP receives a second request frame of a first station STA, where the second request frame is used by a STA to initiate a multi-AP joint sensing by proxy request; and the first AP sends a second response frame to the first STA, where the second response frame indicates that the multi-AP joint sensing by proxy request is accepted.

It should be understood that the first request frames sent by the first AP to the N APs are sent based on the received second request frame.

In the foregoing technical solution, the first STA can initiate the multi-AP joint sensing by proxy request to the first AP, to indicate the first AP to initiate the multi-AP joint sensing by proxy request to another AP. The method enables the first AP to use the sensing result of the one or more APs, thereby avoiding the sensing task failure caused by sensing result unavailability when the first AP performs sensing by proxy alone for the first STA.

In some implementations of the first aspect, the second request frame includes fourth information. The fourth information indicates that the second request frame is a request frame used by the STA to initiate multi-AP joint sensing by proxy. The fourth information is carried in a public action/protected dual of public action Public Action/Protected Dual of Public Action field included in the second request frame.

It may be understood that, in this technical solution, a device that receives the second request frame may determine, based on the fourth information in the second request frame, that a device type of a device that initiates the multi-AP joint sensing by proxy request is a STA.

In some implementations of the first aspect, the second request frame includes fifth information. The fifth information includes a parameter required for multi-AP joint sensing by proxy.

In some implementations of the first aspect, the parameter required for multi-AP joint sensing by proxy includes one or more of the following parameters: a multi-AP joint sensing expiration time, a multi-AP coordinated transmission model, a trigger-based sounding phase model, a number of APs required for establishing multi-AP joint sensing by proxy, whether the number of required APs is mandatory, whether an AP that receives the second request frame needs to perform sensing measurement, a number of required sensing responder STAs, whether the number of sensing responder STAs is mandatory, whether to recommend, to the AP that receives the second request frame, an AP for performing joint sensing by proxy, whether to provide different multi-AP joint sensing by proxy parameters for the recommended AP, and whether the first STA needs to participate in sensing measurement.

In some implementations of the first aspect, when the fifth information indicates to provide different sensing parameters for the recommended AP, the second request frame includes sixth information. The sixth information includes a sensing parameter allocated to each AP in the recommended AP.

In some implementations of the first aspect, the sixth information includes one or more of the following parameters allocated to each AP: a measurement parameter used for sensing, a number of required sensing responder STAs, whether the number of sensing responder STAs is mandatory, and a trigger-based sounding phase model.

In some implementations of the first aspect, the second response frame includes seventh information. The seventh information indicates that the second response frame is a response frame responding to a multi-AP joint sensing by proxy request initiated by a STA. The seventh information is carried in a public action/protected dual of public action Public Action/Protected Dual of Public Action field included in the second response frame.

In some implementations of the first aspect, the method further includes: The first AP triggers the N APs to perform multi-AP joint sensing measurement.

In some implementations of the first aspect, if the second AP in the N APs is not a last AP in the N APs that is triggered to perform sensing measurement, that the first AP triggers the N APs to perform multi-AP joint sensing measurement includes: The first AP determines that the second AP completes sensing measurement; the first AP sends a first polling trigger frame to a third AP in the N APs, where the first polling trigger frame is used to trigger the third AP to perform sensing measurement, and the third AP is any AP in the N APs that is not triggered to perform sensing measurement; and the first AP receives a first polling acknowledgment frame from the third AP.

In the foregoing technical solution, it can be considered that the first AP sequentially triggers the N APs to perform sensing measurement. For example, after an AP #1 in the N APs that is currently triggered by the first AP completes sensing measurement, the first AP sends a polling trigger frame to an AP #2 in the N APs to trigger the AP #2 to perform sensing measurement. After the AP #2 completes sensing measurement, the first AP continues to send a polling trigger frame to an AP #3 in the N APs to trigger the AP #3 to perform sensing measurement, until the first AP triggers all APs in the N APs to complete sensing measurement.

For example, in the measurement triggering manner, the first AP may control sensing measurement of the plurality of APs to be sequentially performed at a quite short time interval. For example, the time interval is generally at a microsecond level. For example, the time interval may be an SIFS interval. In this case, sensing results of all the APs may be considered as soft-synchronized. When a sensing result of the first AP is unavailable due to a reason like interference or excessively weak signal strength on a BSS edge, the sensing results of the N APs at “a same moment” may be used, thereby avoiding the sensing task failure.

In some implementations of the first aspect, that the first AP triggers the N APs to perform multi-AP joint sensing measurement includes: The first AP sends a second polling trigger frame to the N APs, where the second polling trigger frame is used to trigger the N APs to respectively perform sensing measurement based on respective corresponding sensing measurement start times and durations; and the first AP receives second polling acknowledgment frames of the N APs, where the second polling acknowledgment frame indicates that an AP confirms to perform sensing measurement based on a corresponding sensing measurement start time and a corresponding duration.

In the foregoing technical solution, it can be considered that the first AP can allocate, to each AP in the N APs, a sensing measurement start time and a duration for performing sensing measurement, and the N APs perform sensing measurement based on the sensing measurement start times and the durations of the N APs.

In some implementations of the first aspect, the second polling trigger frame includes eighth information. The eighth information includes the start times and the durations for the N APs to perform sensing measurement.

In some implementations of the first aspect, ninth information in the first polling trigger frame is used to trigger an AP that receives the first polling trigger frame to perform multi-AP joint sensing measurement. The ninth information is carried in a sensing trigger subtype Sensing Trigger Subtype field in a trigger dependent common information Trigger Dependent Common Info field in a common information field included in the first polling trigger frame.

In some implementations of the first aspect, the first polling trigger frame includes tenth information. The tenth information indicates the third AP to start to perform sensing measurement.

In some implementations of the first aspect, eleventh information in the second polling trigger frame is used to trigger the N APs to perform multi-AP joint sensing measurement. The eleventh information is carried in a sensing trigger subtype Sensing Trigger Subtype field in a trigger dependent common information Trigger Dependent Common Info field in a common information field included in the second polling trigger frame.

In some implementations of the first aspect, the second polling trigger frame includes twelfth information. The twelfth information indicates the N APs to perform sensing measurement based on the respective corresponding sensing measurement start times and durations.

In some implementations of the first aspect, the method further includes: The first AP sends a first report trigger frame to the N APs, where the first report trigger frame is used to trigger the N APs to report multi-AP joint sensing measurement results; and the first AP receives the measurement results from the N APs.

In some implementations of the first aspect, the method further includes: The first AP sends the measurement results of the N APs to the first STA.

In some implementations of the first aspect, thirteenth information in the first report trigger frame is used to trigger an AP that receives the first report trigger frame to report a multi-AP joint sensing measurement result. The thirteenth information is carried in a sensing trigger subtype Sensing Trigger Subtype field in a trigger dependent common information Trigger Dependent Common Info field in a common information field included in the first report trigger frame.

According to a second aspect, a communication method is provided. The method may be performed by a communication device, or may be performed by a component (for example, a chip or a circuit) of the communication device. This is not limited. For ease of description, the following uses an example in which the method is performed by a second AP for description.

The method includes: The second AP receives a first request frame from a first AP, where the first request frame is used by an AP to initiate a multi-AP joint sensing by proxy request, the second AP is any AP in N APs requested by the first AP for multi-AP joint sensing by proxy, and N is an integer; and the second AP sends a first response frame to the first AP, where the first response frame indicates that the multi-AP joint sensing by proxy request is accepted.

For beneficial effect of the second aspect, refer to the descriptions in the first aspect. Details are not described herein again.

In some implementations of the second aspect, the first request frame includes first information. The first information indicates that the first request frame is a request frame used by an AP to initiate multi-AP joint sensing by proxy. The first information is carried in a public action/protected dual of public action Public Action/Protected Dual of Public Action field included in the first request frame.

In some implementations of the second aspect, the first request frame includes second information. The second information includes a parameter required for the second AP to perform multi-AP joint sensing by proxy.

In some implementations of the second aspect, the parameter required for the second AP to perform multi-AP joint sensing by proxy includes one or more of the following parameters: a multi-AP joint sensing expiration time, a multi-AP coordinated transmission model, a trigger-based sounding phase model, a number of required sensing responder STA sensing responder stations STAs, and whether the number of sensing responder STAs is mandatory.

In some implementations of the second aspect, the first response frame includes third information. The third information indicates that the first response frame is a response frame responding to a multi-AP joint sensing by proxy request initiated by an AP. The third information is carried in a public action/protected dual of public action Public Action/Protected Dual of Public Action field included in the first response frame.

In some implementations of the second aspect, the method further includes: The second AP performs multi-AP joint sensing measurement under triggering of the first AP.

In some implementations of the second aspect, that the second AP performs multi-AP joint sensing measurement under triggering of the first AP includes: The second AP receives a third polling trigger frame from the first AP, where the third polling trigger frame is used to trigger the second AP to perform sensing measurement; and the second AP sends a third polling acknowledgment frame to the first AP.

In some implementations of the second aspect, that the second AP performs multi-AP joint sensing measurement under triggering of the first AP includes: The second AP receives a second polling trigger frame from the first AP, where the second polling trigger frame is used to trigger the N APs to respectively perform sensing measurement based on respective corresponding sensing measurement start times and durations; and the second AP sends a second polling acknowledgment frame to the first AP, where the second polling acknowledgment frame indicates that the second AP confirms to perform sensing measurement based on a corresponding sensing measurement start time and a corresponding duration.

In some implementations of the second aspect, the second polling trigger frame includes eighth information. The eighth information includes the start times and the durations for the N APs to perform sensing measurement.

In some implementations of the second aspect, fourteenth information in the third polling trigger frame is used to trigger the second AP to perform multi-AP joint sensing measurement. The fourteenth information is carried in a sensing trigger subtype Sensing Trigger Subtype field in a trigger dependent common information Trigger Dependent Common Info field in a common information field included in the first polling trigger frame.

In some implementations of the second aspect, the third polling trigger frame includes fifteenth information. The fifteenth information indicates the second AP to start to perform sensing measurement.

In some implementations of the second aspect, eleventh information in the second polling trigger frame is used to trigger the N APs to perform multi-AP joint sensing measurement. The eleventh information is carried in a sensing trigger subtype Sensing Trigger Subtype field in a trigger dependent common information Trigger Dependent Common Info field in a common information field included in the second polling trigger frame.

In some implementations of the second aspect, the second polling trigger frame includes twelfth information. The twelfth information indicates the N APs to perform sensing measurement based on the respective corresponding sensing measurement start times and durations.

In some implementations of the second aspect, the method further includes: The second AP receives a first report trigger frame from the first AP, where the first report trigger frame is used to trigger the second AP to report a multi-AP joint sensing measurement result; and the second AP sends the measurement result to the first AP.

In some implementations of the second aspect, thirteenth information in the first report trigger frame is used to trigger the second AP to report the multi-AP joint sensing measurement result. The thirteenth information is carried in a sensing trigger subtype Sensing Trigger Subtype field in a trigger dependent common information Trigger Dependent Common Info field in a common information field included in the first report trigger frame.

According to a third aspect, a communication method is provided. The method may be performed by a communication device, or may be performed by a component (for example, a chip or a circuit) of the communication device. This is not limited. For ease of description, the following uses an example in which the method is performed by a first STA for description.

The method includes: The first STA sends a second request frame to a first access point AP, where the second request frame is used by a STA to initiate a multi-AP joint sensing by proxy request; and the first STA receives a second response frame from the first AP, where the second response frame indicates that the multi-AP joint sensing by proxy request is accepted.

For beneficial effect of the third aspect, refer to the descriptions in the first aspect. Details are not described herein again.

In some implementations of the third aspect, the second request frame includes fourth information. The fourth information indicates that the second request frame is a request frame used by the STA to initiate multi-AP joint sensing by proxy. The fourth information is carried in a public action/protected dual of public action Public Action/Protected Dual of Public Action field included in the second request frame.

In some implementations of the third aspect, the second request frame includes fifth information. The fifth information includes a parameter required for multi-AP joint sensing by proxy.

In some implementations of the third aspect, the parameter required for multi-AP joint sensing by proxy includes one or more of the following parameters: a multi-AP joint sensing expiration time, a multi-AP coordinated transmission model, a trigger-based sounding phase model, a number of APs required for establishing multi-AP joint sensing by proxy, whether the number of required APs is mandatory, whether an AP that receives the second request frame needs to perform sensing measurement, a number of required sensing responder STAs, whether the number of sensing responder STAs is mandatory, whether to recommend, to the AP that receives the second request frame, an AP for performing joint sensing by proxy, whether to provide different multi-AP joint sensing by proxy parameters for the recommended AP, and whether the first STA needs to participate in sensing measurement.

In some implementations of the third aspect, when the fifth information indicates to provide different sensing parameters for the recommended AP, the second request frame includes sixth information. The sixth information includes a sensing parameter allocated to each AP in the recommended AP.

In some implementations of the third aspect, the sixth information includes one or more of the following parameters allocated to each AP: a measurement parameter used for sensing, a number of required sensing responder STAs, whether the number of sensing responder STAs is mandatory, and a trigger-based sounding phase model.

In some implementations of the third aspect, the second response frame includes seventh information. The seventh information indicates that the second response frame is a response frame responding to a multi-AP joint sensing by proxy request initiated by a STA. The seventh information is carried in a public action/protected dual of public action Public Action/Protected Dual of Public Action field included in the second response frame.

In some implementations of the third aspect, the method further includes: The first STA receives a multi-AP joint sensing measurement result from the first AP.

According to a fourth aspect, a communication apparatus is provided. The communication apparatus is configured to perform the method according to any one of the first aspect to the third aspect. The communication apparatus may include a unit and/or a module configured to perform the method according to any one of the first aspect or the implementations of the first aspect, or include a unit and/or a module configured to perform the method according to any one of the second aspect or the implementations of the second aspect, or include a unit and/or a module configured to perform the method according to any one of the third aspect or the implementations of the third aspect, for example, a processing unit and/or a transceiver unit.

In an implementation, the communication apparatus is a device (for example, a first station, for another example, a first access point, or for another example, a second access point). When the communication apparatus is the device, the transceiver unit may be a transceiver or an input/output interface, and the processing unit may be at least one processor. Optionally, the transceiver may be a transceiver circuit. Optionally, the input/output interface may be an input/output circuit.

In another implementation, the communication apparatus is a chip, a chip system, or a circuit used in a device (for example, a first station, for another example, a first access point, or for another example, a second access point). When the communication apparatus is the chip, the chip system, or the circuit used in the device, the transceiver unit may be an input/output interface, an interface circuit, an output circuit, an input circuit, a pin, a related circuit, or the like in the chip, the chip system, or the circuit; and the processing unit may be at least one processor, a processing circuit, a logic circuit, or the like.

According to a fifth aspect, a communication apparatus is provided. The apparatus includes: a memory, configured to store a program; and at least one processor, configured to execute a computer program or instructions stored in the memory, to perform the method according to any one of the first aspect or the implementations of the first aspect, or perform the method according to any one of the second aspect or the implementations of the second aspect, or perform the method according to any one of the third aspect or the implementations of the third aspect.

In an implementation, the communication apparatus is a device (for example, a first station, for another example, a first access point, or for another example, a second access point).

In another implementation, the apparatus is a chip, a chip system, or a circuit used in a device (for example, a first station, for another example, a first access point, or for another example, a second access point).

According to a sixth aspect, this application provides a processor, configured to perform the methods according to the foregoing aspects.

Operations such as sending and obtaining/receiving related to the processor may be understood as operations such as output, receiving, and input of the processor, or operations such as sending and receiving performed by a radio frequency circuit and an antenna, unless otherwise specified, or provided that the operations do not contradict actual functions or internal logic of the operations in related descriptions. This is not limited in this application.

According to a seventh aspect, a computer-readable storage medium is provided. The computer-readable medium stores program code to be executed by a device. The program code includes instructions used to perform the method according to any one of the first aspect or the implementations of the first aspect, or includes instructions used to perform the method according to any one of the second aspect or the implementations of the second aspect, or includes instructions used to perform the method according to any one of the third aspect or the implementations of the third aspect.

According to an eighth aspect, a computer program product including instructions is provided. When the computer program product runs on a computer, the computer is enabled to perform the method according to any one of the first aspect or the implementations of the first aspect, or the computer is enabled to perform the method according to any one of the second aspect or the implementations of the second aspect, or the computer is enabled to perform the method according to any one of the third aspect or the implementations of the third aspect.

According to a ninth aspect, a chip is provided. The chip includes a processor and a communication interface. The processor reads, through the communication interface, instructions stored in a memory, to perform the method according to any one of the first aspect or the implementations of the first aspect, or perform the method according to any one of the second aspect or the implementations of the second aspect, or perform the method according to any one of the third aspect or the implementations of the third aspect.

Optionally, in an implementation, the chip further includes a memory. The memory stores a computer program or instructions. The processor is configured to execute the computer program or the instructions stored in the memory. When the computer program or the instructions are executed, the processor is configured to perform the method according to any one of the first aspect or the implementations of the first aspect, or perform the method according to any one of the second aspect or the implementations of the second aspect, or perform the method according to any one of the third aspect or the implementations of the third aspect.

According to a tenth aspect, a communication system is provided, including the foregoing first station, first access point, and second access point.

### BRIEF DESCRIPTION OF DRAWINGS

FIG. 1 is a diagram of a network architecture of a wireless local area network applicable to an embodiment of this application;

FIG. 2 is a diagram of a WLAN sensing procedure defined in IEEE 802.11bf;

FIG. 3 is a diagram of a trigger-based sensing measurement exchange procedure;

FIG. 4 is a diagram in which an AP and a STA perform TB sensing measurement exchange sensing measurement;

FIG. 5 is a diagram of an SBP procedure;

FIG. 6 is a schematic flowchart of a sensing method according to this application;

FIG. 7 is a diagram of a frame structure of a possible first request frame according to this application;

FIG. 8 is a diagram of a structure of a co-sensing parameters control field in a first request frame according to this application;

FIG. 9 is a diagram of a frame structure of a possible first response frame according to this application;

FIG. 10 is a diagram of a frame structure of a possible second request frame according to this application;

FIG. 11 is a diagram of a structure of a Co-SBP parameters control field in a second request frame according to this application;

FIG. 12 is a diagram of a structure of a MAP parameters control field in a second request frame according to this application;

FIG. 13 is a diagram of a frame structure of a possible second response frame according to this application;

FIG. 14A and FIG. 14B are a diagram of a multi-AP joint sensing procedure corresponding to Scenario 1;

FIG. 15A and FIG. 15B are a diagram of a multi-AP joint sensing procedure corresponding to Scenario 2;

FIG. 16 is a diagram in which a plurality of APs perform joint sensing based on Implementation 1;

FIG. 17 is a diagram in which a plurality of APs perform joint sensing based on Implementation 2;

FIG. 18 is a diagram of a frame structure of a possible Co-SBP polling trigger frame according to this application;

FIG. 19 is a diagram of a structure of a user info list field in a Co-SBP polling trigger frame according to this application;

FIG. 20 is a block diagram of a communication apparatus 200 according to an embodiment of this application; and

FIG. 21 is a block diagram of a communication apparatus 300 according to an embodiment of this application.

### DESCRIPTION OF EMBODIMENTS

The following describes technical solutions in this application with reference to accompanying drawings.

Embodiments of this application may be applied to a wireless local area network (WLAN). Currently, a standard used for the WLAN is the institute of electrical and electronics engineering (IEEE) 802.11 series. The WLAN may include a plurality of basic service sets (BSSs). Network nodes in the BSS are an access point (AP) and a non-access point station (non-AP STA) (referred to as a STA for short below).

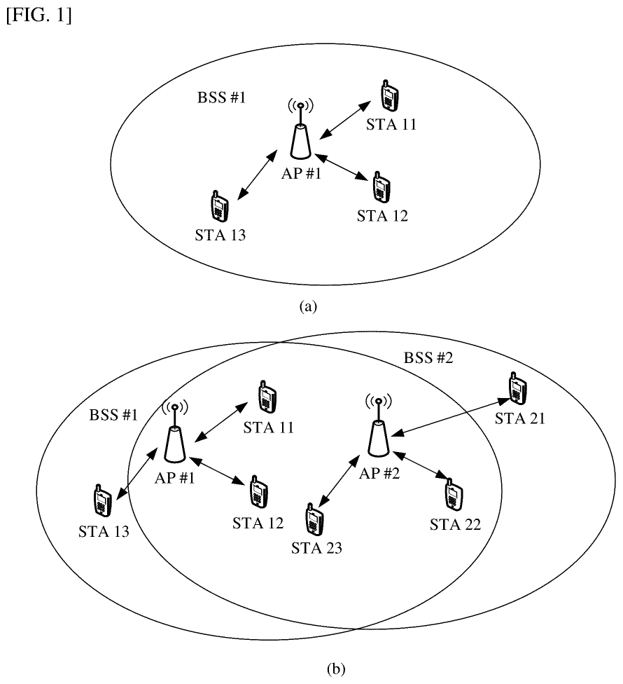

FIG. 1 is a diagram of a network architecture of a wireless local area network applicable to an embodiment of this application. As shown in (a) in FIG. 1, one BSS may include one AP and one or more STAs associated with the AP. The network architecture of the wireless local area network may alternatively include a plurality of BSSs. For example, (b) in FIG. 1 shows two BSSs, and the two BSSs partially overlap, that is, are an OBSS. A BSS #1 includes an AP #1, a STA 11, a STA 12, and a STA 13, and a BSS #2 includes an AP #2, a STA 21, a STA 22, and a STA 23. The STA 11, the STA 12, the STA 22, and the STA 23 are mutually overlapping parts of the two BSSs. Each BSS includes an AP and a plurality of STAs. In one BSS, data may be transmitted between the AP and each STA. The AP #1 and the AP #2 may also communicate with each other.

The access point may be an access point used by a terminal (for example, a mobile phone) to access a wired (or wireless) network, and is mainly deployed at home, in a building, and in a campus. A typical coverage radius is tens of meters to 100-odd meters. Certainly, the access point may alternatively be deployed outdoors. The access point is equivalent to a bridge that connects the wired network to the wireless network. A main function of the access point is to connect various wireless network clients together and then connect the wireless network to an ethernet.

The AP may be a terminal or a network device with a Wi-Fi chip. The network device may be a server, a router, a switch, a bridge, a computer, a mobile phone, a relay station, a vehicle-mounted device, a wearable device, a network device in a 5G network, a network device in a future 6G network, a network device in a public land mobile network (PLMN), or the like. This is not limited in embodiments of this application. The access point may be a device that supports a Wi-Fi standard. For example, the access point may alternatively support one or more standards of the institute of electrical and electronics engineers (IEEE) 802.11 family, such as 802.11a, 802.11b, 802.11g, 802.11n, 802.11ac, 802.11ax, 802.11be, 802.11ad, and 802.11ay.

The STA may be a wireless communication chip, a wireless sensor, a wireless communication terminal, or the like, and may also be referred to as a user, user equipment (UE), an access terminal, a subscriber unit, a subscriber station, a mobile station, a remote station, a remote terminal, a mobile device, a user terminal, a terminal, a wireless communication device, a user agent, or a user apparatus. The STA may be a cellular phone, a cordless phone, a session initiation protocol (SIP) phone, a wireless local loop (WLL) station, a personal digital assistant (PDA), a handheld device having a wireless communication function, a computing device, another processing device connected to a wireless modem, a vehicle-mounted device, an internet of things device, a wearable device, a terminal device in the 5G network, a terminal device in the future 6G network, a terminal device in the PLMN, or the like. This is not limited in embodiments of this application. The STA may be a device that supports a WLAN standard. For example, the STA may support one or more standards of the IEEE 802.11 family, such as 802.11a, 802.11b, 802.11g, 802.11n, 802.11ac, 802.11ax, 802.11be, 802.11ad, and 802.11ay.

For example, the STA may be a mobile phone, a tablet computer, a set-top box, a smart television, a smart wearable device, a vehicle-mounted communication device, a computer, an internet of things (IoT) node, a sensor, a smart home like a smart camera, a smart remote control, or a smart water/electricity meter, or a sensor in a smart city.

The AP or the STA may include a transmitter, a receiver, a memory, a processor, and the like. The transmitter and the receiver are respectively configured to: send and receive packet structures. The memory is configured to: store signaling information, store a preset value agreed on in advance, and the like. The processor is configured to: parse the signaling information, process related data, and the like.

It should be understood that FIG. 1 is merely an example, and should not be construed as a limitation on the network architecture of the wireless local area network to which this application is applicable. For example, the network architecture may alternatively include more BSSs, and each BSS may alternatively include more STAs, or an area in which a plurality of BSSs overlap may alternatively include more STAs. This is not limited in embodiments of this application.

WLAN sensing is a quite promising technology, and uses widely deployed WLAN devices and a WLAN signal to perform a sensing task. In a propagation process, the WLAN signal may be reflected, refracted, or penetrated on a surface of an object. A WLAN signal echo is received and appropriate signal processing is performed according to an algorithm, so that the received WLAN signal may be used to sense a surrounding environment, detect an obstacle, or monitor a moving target.

A unified WLAN sensing procedure is defined in an IEEE 802.11bf protocol, so that a device can obtain channel state information (CSI) between two or more devices, to sense environment information. In IEEE 802.11bf, different roles are introduced to devices participating in sensing, to cover an identified sensing scenario, which may be summarized as follows: A sensing initiator is a device that initiates WLAN sensing: a sensing responder is a device that responds to WLAN sensing initiated by the sensing initiator: a sensing transmitter is a device that transmits a null data packet (NDP); and a sensing receiver is a device that receives the NDP sent by the sensing transmitter and performs sensing measurement based on the NDP.

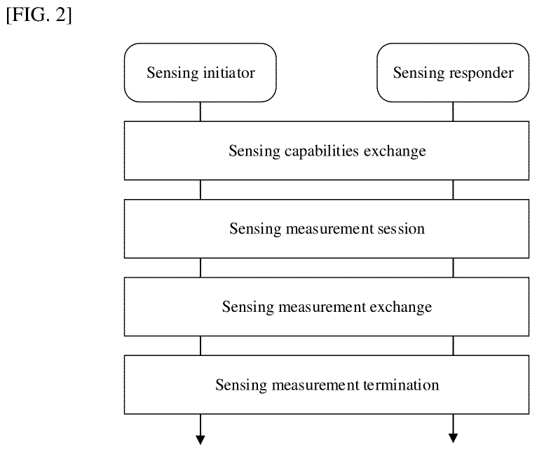

FIG. 2 is a diagram of a WLAN sensing procedure defined in IEEE 802.11bf. In a sensing capabilities exchange phase, sensing capabilities information of devices is exchanged. In a sensing measurement session phase, a sensing initiator and a sensing responder negotiate WLAN sensing operation information through a request/response frame. In a sensing measurement exchange phase, a sensing transmitter and a sensing receiver perform sensing measurement through an NDP frame. In a sensing measurement termination phase, a corresponding WLAN sensing setting is terminated. Sensing measurement exchange is classified into trigger-based (TB) sensing measurement exchange and non-trigger-based (Non-TB) sensing measurement exchange. TB sensing measurement exchange is an AP-centric mechanism, where an AP is used as the sensing initiator, and one or more STAs are used as sensing responders.

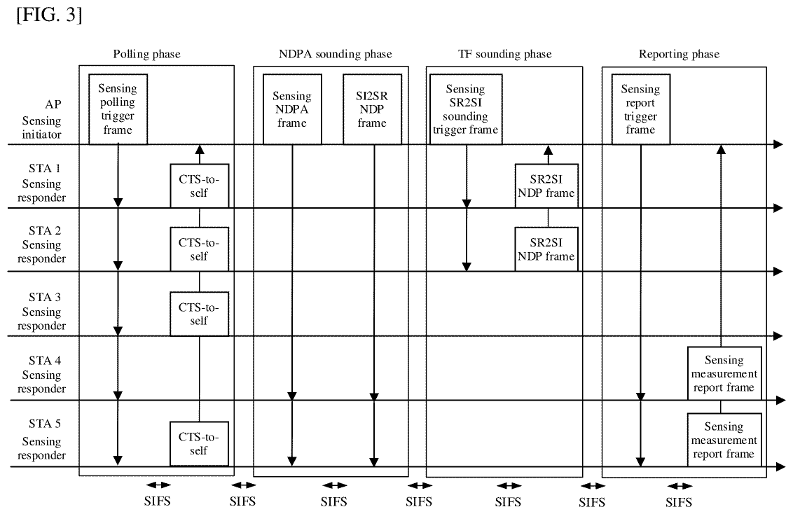

FIG. 3 is a diagram of a trigger-based sensing measurement exchange procedure. The procedure includes a polling phase, a null data packet announcement (NDPA) sounding phase, a trigger frame (TF) sounding phase, and a reporting phase. It should be noted that trigger-based sensing measurement exchange should not include only the reporting phase, should not include only the NDPA sounding phase, and should not include only the polling phase and the reporting phase. The following describes the procedure. In the polling phase, an AP first sends a sensing polling trigger frame to one or more STAs that are expected to participate in sensing measurement. The STA responds through a clear to send (CTS) to self (CTS-to-self) frame to confirm to participate in subsequent sensing measurement. After polling, the AP initiates NDPA sounding and/or TF sounding based on roles negotiated in a sensing measurement session. In the NDPA sounding phase, the AP, as a sensing transmitter, sends a sensing NDPA frame, and after a short interframe space (SIFS) interval, the AP sends an SI2SR NDP frame. The STA, as a sensing receiver, receives the SI2SR NDP frame to perform sensing measurement. In the TF sounding phase, the AP, as a sensing receiver, sends a sensing SR2SI sounding trigger frame to trigger one or more STAs, as sensing transmitters, to send an SR2SI NDP frame to the AP, so that the AP performs sensing measurement. After the sounding phase ends, the AP triggers, through a sensing report trigger frame, the STA to return a sensing measurement result.

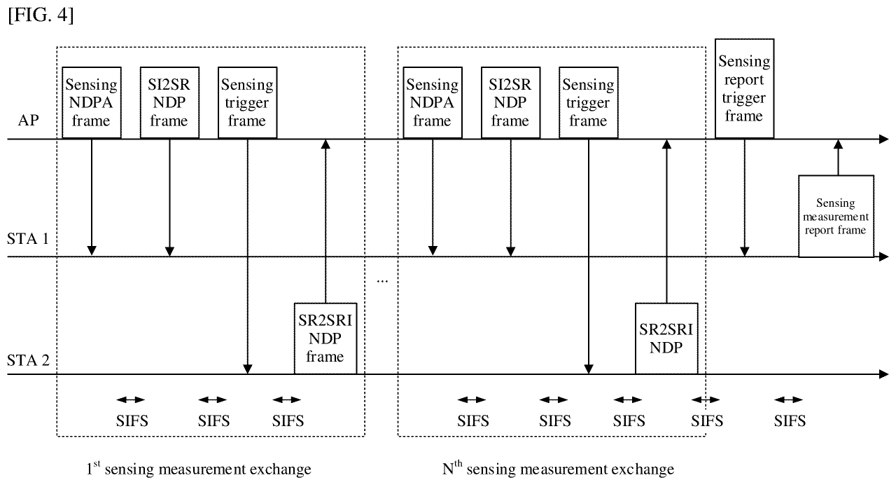

FIG. 4 is a diagram in which an AP and a STA perform TB sensing measurement exchange sensing measurement. In a sensing window, the AP and the STA need to perform N times of sensing measurement exchange measurement. In this process, the AP and the STA complete the N times of sensing measurement exchange measurement as long as a communication link is not disconnected. Then, a sensing measurement report is returned.

In a possible scenario, when sensing a target in an OBSS, the AP may be subject to interference from another device in space, for example, co-channel or adjacent-channel interference, and have poor sensing performance because the sensed target is on an edge of a BSS. As a result, a measurement result has a large error. However, in the sensing measurement exchange process, sensing measurement exchange keeps being performed as long as the communication link is not interrupted. It can be learned, only after the sensing measurement report is obtained and signal processing is performed according to an algorithm, that the sensing measurement result has the large error. In this case, a plurality of sensing measurement exchange results cannot be used, and therefore, the measurement result can be only discarded, resulting in a sensing task failure.

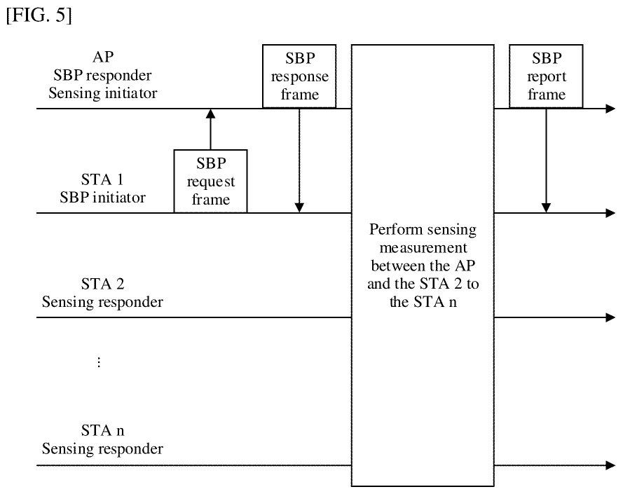

FIG. 5 is a diagram of an SBP procedure. SBP is a process in which a STA is allowed to request an AP to perform sensing measurement on behalf of the STA. First, a STA 1, as an SBP initiator, requests, through an SBP request frame, an AP, as an SBP responder, to perform SBP, and the AP replies to the request of the STA 1 through an SBP response frame. After accepting the SBP request of the STA 1, the AP, as a sensing initiator, searches for an appropriate STA in a BSS to complete WLAN sensing. After completing WLAN sensing, the AP returns a measurement result to the STA 1 through an SBP report frame.

Therefore, a plurality of APs may perform joint sensing on a same target. When a sensing result of an AP is unavailable, a sensing result of another AP may be used. However, existing SBP does not support an AP in requesting an AP to perform sensing by proxy, that is, multi-AP joint sensing cannot be established based on existing SBP.

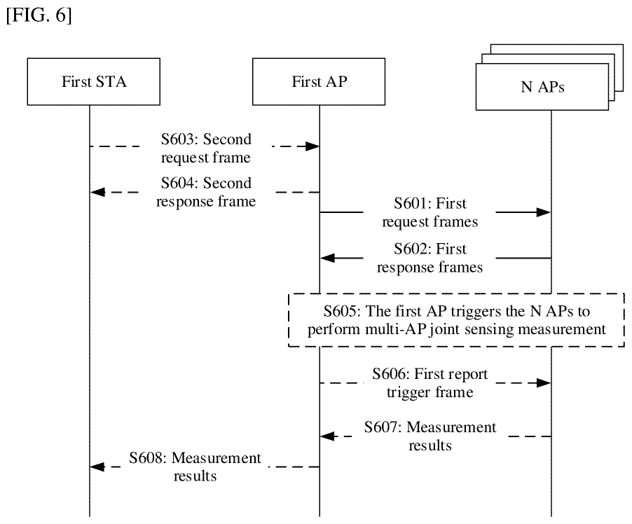

In view of this, this application provides a sensing method, to implement multi-AP joint sensing. When a sensing result of an AP is unavailable, a sensing result of another AP may be used. With reference to FIG. 6, the following describes in detail the method provided in this application.

FIG. 6 is a schematic flowchart of a sensing method according to this application. The method includes the following steps.

S601: A first AP separately sends, to N APs, first request frames corresponding to the N APs, where the first request frame is used by an AP to initiate a multi-AP joint sensing by proxy request, and N is a positive integer. Correspondingly, the N APs respectively receive the first request frames from the first AP.

For ease of description, in this application, multi-AP joint sensing by proxy may be referred to as coordinated sensing by proxy (Co-SBP).

It should be noted that, in this solution, multi-AP joint sensing by proxy may be joint sensing performed by a plurality of APs on a same target: or multi-AP joint sensing by proxy may be sensing respectively performed on different parts of the same target, where the first AP may obtain a sensing result of the entire target based on sensing results of different APs: or multi-AP joint sensing by proxy may be joint sensing performed on an environment. A sensed target of multi-AP joint sensing is not specifically limited in this application.

Optionally, because the first AP needs to perform multi-AP joint sensing with the plurality of APs, in this application, the first AP may select M (M is greater than or equal to N) APs from a multi-AP coordination set based on a requirement of the first AP or another condition, and separately send first request frames to the M APs. The N APs in this application may be considered as APs that finally participate in multi-AP joint sensing. It should be noted that any AP in the multi-AP coordination set may obtain related information of all APs in the multi-AP coordination set.

Optionally, the first request frame includes first information. The first information indicates that the first request frame is a request frame used by an AP to initiate multi-AP joint sensing by proxy. A device that receives the first request frame may determine, based on the first information in the first request frame, that a device type of a device that initiates the Co-SBP request is an AP.

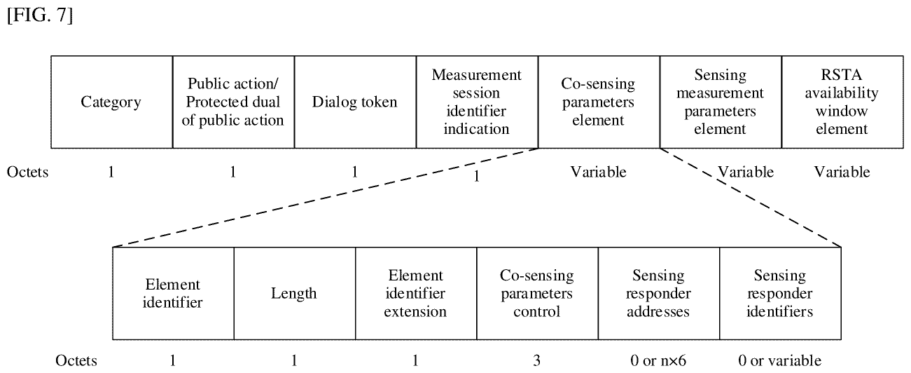

Optionally, the first request frame includes second information. The second information includes a parameter required for a second AP to perform multi-AP joint sensing by proxy. The second AP is an AP that receives the first request frame. For example, the parameter required for the second AP to perform multi-AP joint sensing by proxy includes one or more of the following parameters: a multi-AP joint sensing expiration time, a multi-AP coordinated transmission model, a trigger-based sounding phase model, a number of required sensing responder STAs, and whether the number of sensing responder STAs is mandatory. Meanings of the parameters are described in detail with reference to FIG. 7, and are not described herein.

Optionally, the first request frame may further include information about a type of a sensing measurement result of the second AP. The second AP obtains a corresponding measurement result based on the type information. The second AP is an AP that receives the first request frame. For example, the first request frame may include information about one or more types. For example, the type of the sensing measurement result may be a CSI matrix.

S602: The N APs respectively send respective corresponding first response frames to the first AP, where the first response frame indicates that the multi-AP joint sensing by proxy request is accepted. Correspondingly, the first AP separately receives the first response frames from the N APs.

For example, the N APs may determine, based on capabilities of the N APs and associated STAs, whether the N APs can accept the Co-SBP request of the first AP, and directly reply to the first AP in the first response frames. For example, if an AP #1 in the N APs determines that the AP #1 can accept the Co-SBP request of the first AP, the AP #1 sends a first response frame to the first AP. The first response frame indicates that the AP #1 accepts the Co-SBP request of the first AP. Then, the AP #1 establishes a sensing measurement session. It may be understood that establishing the sensing session herein means that the AP #1 establishes the sensing session with a STA associated with the AP #1, in preparation for the AP #1 to subsequently perform joint sensing measurement. For example, the AP #1 may send a sensing measurement request frame to an associated STA #1, and the STA #1 sends a sensing measurement response frame to the AP #1, to indicate whether the sensing session is successfully established.

For example, the AP #1 in the N APs may alternatively first attempt to establish the sensing measurement session, and then reply to the first AP based on a session establishment result.

A sequence of establishing the sensing measurement session and replying with the first response frame by the AP #1 is not limited in this application provided that an interval between the first request frame and the first response frame does not exceed 20 ms.

Optionally, the first response frame includes third information. The third information indicates that the first response frame is a response frame responding to a multi-AP joint sensing by proxy request initiated by an AP.

Optionally, embodiments of this application may be applied to the following two scenarios. The following briefly describes procedures of the two scenarios.

Scenario 1: The first AP may actively initiate the Co-SBP request to the N APs based on the requirement of the first AP. For ease of description, in this application, in this scenario, the first AP is referred to as a co-sensing initiator, and the N APs are referred to as co-sensing responders.

Scenario 2: A first STA may actively initiate a Co-SBP request to the first AP based on a requirement of the first STA, and the first AP passively initiates the Co-SBP request to the N APs based on the request of the first STA. It can be learned that two Co-SBP requests are initiated in Scenario 2. For ease of distinction in description, in this application, in this scenario, a device that initiates a 1^{st} Co-SBP request (namely, the first STA) is referred to as a Co-SBP initiator, and the first AP that responds to the Co-SBP request of the first STA is referred to as a Co-SBP responder. Then, the first AP further needs to initiate a 2^{nd} Co-SBP request to the N APs. Therefore, in this application, a device that initiates the 2^{nd} Co-SBP request (namely, the first AP) is referred to as a co-sensing initiator, and the N APs that respond to the Co-SBP request of the first AP are referred to as co-sensing responders.

It should be understood that S601 and S602 may be considered as a procedure corresponding to the Co-SBP request in Scenario 1 or a procedure corresponding to the 2^{nd} Co-SBP request in Scenario 2. Optionally, if a corresponding scenario is Scenario 2, the first STA further needs to initiate the 1^{st} Co-SBP request before the first AP initiates the 2nd Co-SBP request. For a procedure in which the first STA initiates the 1^{st} Co-SBP request, refer to descriptions in S603 and S604. Details are not described herein.

FIG. 7 is a diagram of a frame structure of a possible first request frame according to this application. The first request frame may be considered as an SBP request frame that is redesigned based on an existing SBP request frame and that is used by the AP to request multi-AP joint sensing. The existing SBP request frame cannot support a multi-AP joint sensing scenario in this application, and cannot indicate a multi-AP joint sensing parameter. However, the first request frame provided in FIG. 7 can support the multi-AP joint sensing scenario in this application and implement a function of allocating a joint sensing parameter to each AP. For example, in this application, the first request frame may be referred to as a co-sensing request frame.

It should be understood that numbers of bits occupied by fields in a request frame and a response frame that are provided in accompanying drawings of embodiments of this application are merely examples, and should not constitute a limitation on frame structures or frame lengths of the request frame and the response frame provided in this application.

It should be further understood that names of the request frame and the response frame and names of the included fields provided in the accompanying drawings of embodiments of this application are merely examples, and should not constitute a limitation on the request frame and the response frame provided in this application.

As shown in FIG. 7, the first request frame includes a category field, a public action/protected dual of public action field, a dialog token field, a measurement session identifier indication (Measurement Session ID Indication) field, a co-sensing parameters element field, a sensing measurement parameters element field, and a responding STA (RSTA) availability window element field. The following describes some fields related to this application in the first request frame.

(1) A frame type is newly added to the existing SBP request frame for the first request frame, to indicate that the first request frame is an SBP request frame used by the AP to initiate the multi-AP joint sensing request, and indicate that the frame allocates a joint sensing parameter to an AP that receives the frame. For example, in this application, the frame type is extended in a public action/protected dual of public action field in the existing SBP request frame, to indicate that the frame is the first request frame. For example, as shown in Table 1, when a value of the public action/protected dual of public action field is 62 (namely, an example of the first information), it indicates that the current SBP request frame is the first request frame.

TABLE 1

| Value of the | |
|---|---|
| public action field | Meaning |
| 51 | Sensing measurement request |
| 52 | Sensing measurement response |
| 53 | Sensing measurement report |
| . . . | . . . |
| 59 | SBP report |
| 60 | Co-SBP request |
| 61 | Co-SBP response |
| 62 | Co-sensing request |
| 63 | Co-sensing response |

(2) The measurement session ID indication field in the first request frame indicates a measurement session ID, and the measurement session ID indicates a sensing measurement parameter to be used in corresponding sensing measurement exchange. An existing field is directly reused herein. Details are not described herein.

(3) The RSTA availability window element field in the first request frame is a time and cycle that are allocated by the first AP to the N APs and that are used for multi-AP joint sensing, namely, an available time window. Multi-AP joint sensing needs to be performed in the allocated time window.

(4) The sensing measurement parameters element field in the first request frame indicates a sensing parameter allocated to the AP #1 that receives the first request frame. For example, the field includes a bandwidth (bandwidth, BW) field, a maximum (Max) transmit (TX) space-time stream (STS) and max receive (RX) STS field, and a number of receive antennas (Number of RX Antennas) field. The BW field indicates a sensing measurement bandwidth, the max TX STS and max RX STS field indicates a maximum space-time stream, and the number of RX antennas field indicates a number of antennas used by a sensing receiver. In a possible implementation, a design of the field may be the same as that of a sensing measurement parameters element field in the existing SBP request frame.

(5) The co-sensing parameter element field is newly defined in the first request frame.

It should be noted that a name of a newly added field in the first request frame is merely an example provided for ease of description. If information carried in a field and a function implemented by the field are the same as information carried in the newly added field provided in this application and a function implemented by the newly added field, it may be considered that the field and the newly added field provided in this application are a same field. A name of a newly added field in the first request frame or another frame provided below is also merely an example. Details are not described below again.

It should be further noted that a length of the newly added field in the first request frame is merely an example provided for ease of description, and the field length should not limited. A length of the newly added field in the first request frame or the another frame provided below is also merely an example. Details are not described below again.

As shown in FIG. 7, the co-sensing parameter element field includes an element identifier (Element ID) field, a length field, an element identifier extension (Element ID Extension) field, a co-sensing parameters control field, a sensing responder addresses field, and a sensing responder identifiers (Sensing Responder IDs) field. The following describes some fields related to this application in the co-sensing parameter element field.

(1) The element ID field and the element ID extension field in the co-sensing parameter element field are used to jointly indicate a type and a use scenario of a corresponding element. In this application, the element ID extension is extended to indicate that the element carries the joint sensing parameter allocated to the AP #1 that receives the first request frame. In this application, an element ID, a length, and the element ID extension follow designs in IEEE 802.11bf. For example, as shown in Table 2, an element type is extended in the element ID. When a value of the element ID extension is <Last assigned+18>, it is considered that the element carries the joint sensing parameter allocated to the AP #1 that receives the first request frame.

TABLE 2

| | Element identifier | Element identifier extension |
|---|---|---|
| Element | (Element ID) | (Element ID Extension) |
| Sensing measurement | 255 | <Last assigned + 1> |
| request | | |
| (Sensing | | |
| Measurement Parameters) | | |
| Sensing capabilities | 255 | <Last assigned + 2> |
| element | | |
| SBP parameters | 255 | <Last assigned + 3> |
| . . . | . . . | . . . |
| DMG SBP parameters | 255 | <Last assigned + 16> |
| element | | |
| Co-SBP parameters | 255 | <Last assigned + 17> |
| element | | |
| Co-sensing | 255 | <Last assigned + 18> |
| parameters element | | |

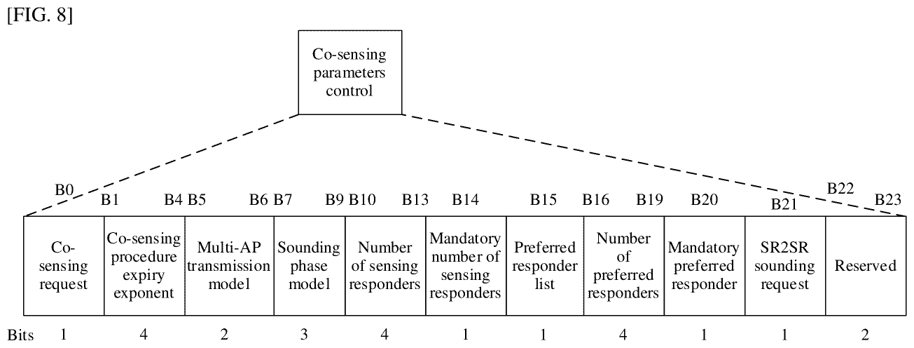

(2) The co-sensing parameter control field in the co-sensing parameter element field is used to carry the second information. For example, FIG. 8 is a diagram of a structure of the co-sensing parameters control field. The co-sensing parameters control field includes a co-sensing request field, a co-sensing procedure expiry exponent field, a multi-AP transmission model (MAP Transmission Model) field, a sounding phase model field, a number of sensing responders field, a mandatory number of sensing responders (Mandatory Number of Responders) field, a preferred responder list field, a number of preferred responders field, a mandatory preferred responder field, and a sensing responder to sensing responder (SR2SR) sounding request field. The following describes meanings of the fields in the co-sensing parameters control field and parameters in the second information that are carried.

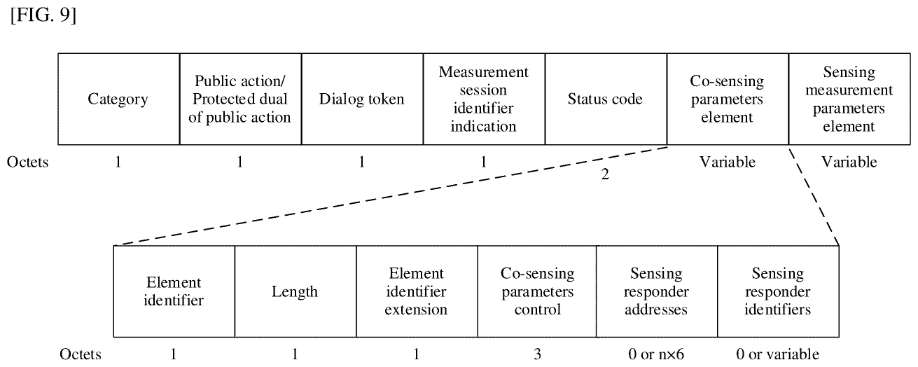

The co-sensing request field indicates a frame in which a co-sensing parameters element is carried. For example, the co-sensing request field is set to “1” to indicate that the co-sensing parameters element is carried in a request frame for multi-AP joint sensing initiated by the AP, or is set to “0” to indicate that the co-sensing parameters element is carried in a response frame responding to multi-AP joint sensing initiated by the AP. It should be noted that, because the first request frame is a request frame for multi-AP joint sensing initiated by the AP, a value of the field in the first request frame is 1. In addition, the first response frame also includes the field (referring to FIG. 9). Because the first response frame is a response frame responding to multi-AP joint sensing initiated by the AP, the value of the field in the first response frame is 0. Because the public action/protected dual of public action field in the first request frame has indicated that the first request frame is a request frame for multi-AP joint sensing initiated by the AP, the field in the first request frame may be an optional field.

The co-sensing procedure expiry exponent field is used by an AP that obtains the field to determine whether to terminate multi-AP joint sensing (e.g., the multi-AP joint sensing expiration time in the second information is carried in the field). The co-sensing procedure expiry exponent includes an unsigned integer, and may indicate a time length. In a time window agreed on for multi-AP joint sensing, after detecting a frame on a channel through listening, the AP that obtains the field starts to count down a duration indicated by the field. When countdown ends, if there is still no frame exchange on the channel, the AP considers that a current multi-AP joint sensing procedure ends. For example, a value of the field may be 2^{(Co-SBP Procedure Expiry Exponent+8)} milliseconds.

The MAP transmission model field indicates the multi-AP coordinated transmission model, to support the plurality of APs in coordinated transmission of a frame in a sensing measurement process. For example, the field may indicate different transmission models by using 2 bits. For example, when the MAP transmission model field is 00 (that is, a value is 0), it indicates that the multi-AP coordinated transmission model is coordinated beamforming (CBF). The N APs may send the frame in the sensing measurement process based on CBF. This application is not limited to CBF. In the future, a multi-AP coordinated transmission method suitable for this application may be indicated by using another value in the MAP transmission model field.

The sounding phase model field indicates a TB sounding phase model established by an AP that receives the first request frame. For example, the field may indicate different TB sounding phases by using 2 bits. For example, when the sounding phase model field is 00 (that is, a value is 0), the AP #1 that receives the first request frame can select only to establish an NDPA sounding phase: when the sounding phase model field is 01 (that is, the value is 1), the AP #1 that receives the first request frame can select only to establish a TF sounding phase; and when the sounding phase model field is 10 (that is, a value is 2), the AP #1 can select one of the NDPA sounding phase and the TF sounding phase.

It may be understood that the foregoing method for indicating the sounding phase model through the sounding phase model field is merely an example, and this application does not exclude another method that can indicate the sounding phase model. For example, in this application, the sounding phase model may alternatively be indicated by using a method for allocating a transmitter/receiver role to different sensing responders by using a “Sensing Responder Role Bitmap” field in existing SBP. This is not limited in this application.

The number of sensing responders field indicates a number of sensing responders included in sensing that needs to be established by the AP #1 that receives the first request frame (that is, the number of required sensing responder STAs in the second information is carried in the field).

The mandatory number of responders field indicates whether the number of sensing responders indicated in the number of sensing responders field is mandatory. For example, the field may be indicated by using 1 bit. When the mandatory number of responders field is “0”, it indicates that the number of STAs indicated in the number of sensing responders field is optional, and the number of STAs may be considered as a reference quantity and may be satisfied as much as possible. On the contrary, when the mandatory number of responders field is “1”, it indicates that the number of STAs indicated in the number of sensing responders field necessarily meets a requirement.

The preferred responder list field indicates whether to provide a preferred sensing responder list for the AP #1 that receives the first request frame. For example, when the preferred responder list field is “1”, it indicates to provide the preferred sensing responder list for the AP #1, and carry address information of a recommended sensing responder in the co-sensing parameter element in the first request frame (carry in the sensing responder addresses field in the first request frame), and the AP #1 needs to search for a STA in the preferred sensing responder list to initiate a sensing request. When the preferred responder list field is “0”, it indicates not to recommend a sensing responder to the AP #1, and the AP #1 searches for an appropriate STA in a BSS of the AP #1 to initiate the sensing request.

The number of preferred responders field indicates a number of sensing responders recommended to the AP #1 that receives the first request frame. If the preferred responder list field is “1”, the number of preferred responders field indicates medium access control (MAC) addresses of a number of recommended sensing responders included in the sensing responder addresses field. If the preferred responder list field is “0”, the field is reserved. For example, the character may be set to 0), and the AP #1 does not read the field.

The mandatory preferred responder field indicates whether the sensing responder recommended to the AP #1 that receives the first request frame is mandatory. For example, the field may be indicated by using 1 bit. When the mandatory preferred responder field is “0”, it indicates that the recommended sensing responder is not necessarily mandatory, the recommended sensing responder may be considered as a reference, and a sensing responder that finally participates in sensing is searched for in the recommended sensing responder as much as possible. On the contrary, when the mandatory preferred responder field is “1”, it indicates that the sensing responder that finally participates in sensing is necessarily searched for in the recommended sensing responder.

The SR2SR sounding request field indicates whether SR2SR sensing needs to be established. For example, when the SR2SR sounding request field is “0”, it indicates that SR2SR sensing does not need to be established, and when the SR2SR sounding request field is “1”, it indicates that SR2SR sensing needs to be established.

(3) The sensing responder addresses field in the co-sensing parameter element field carries the address information of the sensing responder recommended to the AP #1 that receives the first request frame. It may be understood that the sensing responder addresses field exists in the first request frame only when the preferred responder list field indicates to recommend the sensing responder to the AP #1. In this case, the sensing responder addresses field includes one or more MAC addresses, and these addresses indicate MAC addresses of STAs for sensing established by the AP #1.

(4) The sensing responder IDs field in the co-sensing parameter element field occupies 0 bits.

The foregoing describes in detail the possible first request frame provided in FIG. 7. For example, the following describes a frame structure of a possible first response frame with reference to FIG. 9.

FIG. 9 is a diagram of the frame structure of the possible first response frame according to this application. For example, in this application, the first response frame may be referred to as a co-sensing response frame. As shown in FIG. 9, the frame structure of the first response frame is basically the same as that of the first request frame. The first response frame includes a category field, a public action/protected dual of public action field, a dialog token field, a measurement session ID indication field, a status code field, a co-sensing parameters element field, and a sensing measurement parameters element field. Herein, only fields that carry different information in the first response frame and the first request frame are described.

(1) A frame type is extended in the public action/protected dual of public action field in the first response frame, to indicate that the first response frame is a response frame responding to a multi-AP joint sensing by proxy request initiated by an AP. For example, as shown in Table 1, when a value of the public action/protected dual of public action field is “63” (namely, an example of the first information), it indicates that the first response frame is a response frame responding to a multi-AP joint sensing by proxy request initiated by an AP.

(2) The status code field in the first response frame indicates whether the AP #1 that receives the first request frame receives the request of the first request frame. For example, if the AP #1 receives the request, the status code field is set to SUCCESS: or if the AP #1 rejects the request, the status code field is set to REQUEST_DECLINED or REJECTED_WITH_SUGGESTED_CHANGES (which is completely the same as an existing status code field in 11bf).

(3) The co-sensing parameter element field is newly defined in the first response frame. A design of the co-sensing parameter element field in the first response frame is the same as that of the co-sensing parameter element field in the first request frame, and only meanings of some fields are different. The following describes only the fields whose meanings are different.

(1) If a co-sensing request field in a co-sensing parameter control field in the co-sensing parameters element field in the first response frame exists, for example, when a value of the co-sensing request field is 1, it indicates that the co-sensing parameters element is carried in the request frame for multi-AP joint sensing initiated by the AP, or when the value is 0), it indicates that the co-sensing parameters element is carried in the response frame responding to multi-AP joint sensing initiated by the AP. In this case, the value of the field in the first response frame needs to be set to 0), to indicate that the co-sensing parameters element is carried in the first response frame. Because the public action/protected dual of public action field in the first response frame has indicated that the first response frame is a response frame responding to multi-AP joint sensing initiated by the AP, the field in the first response frame may be an optional field.

(2) The co-sensing procedure expiry exponent field, the MAP transmission model field, the sounding phase model field, the mandatory number of responders field, the mandatory preferred responder field, and the SR2SR sounding request field are reserved in the first response frame. For example, when the character is reserved, the field may be set to 0, and the first AP may not read these fields.

(3) A number of sensing responders field has different meanings based on a variation of the status code field. For example, if the status code field in the first response frame is equal to SUCCESS, the number of sensing responders field indicates a number of sensing responders included in sensing that is actually established by the AP #1 that receives the first request frame. If the status code field in the first response frame is equal to REJECTED_WITH_SUGGESTED_CHANGES, the number of sensing responders field is used to suggest a value of the field carried in the first request frame when the first AP initiates multi-AP joint sensing next time.

(4) A preferred responder list field indicates a sensing responder included in sensing established by the AP #1 that receives the first request frame. The field indicates whether a sensing responder addresses field and a sensing responder IDs field exist. For example, when the preferred responder list field is “1”, it indicates that the sensing responder addresses field and the sensing responder IDs field exist, and include an address and an ID of the sensing responder included in sensing established by the AP #1 that receives the first request frame: or when the preferred responder list field is “0”, it indicates that the sensing responder addresses field and the sensing responder IDs field do not exist.

(5) A number of preferred responders field indicates a number of MAC addresses included in the sensing responder addresses field. For example, if the preferred responder list field is “1”, the number of preferred responders field indicates MAC addresses of a number of sensing responders included in the sensing responder addresses field. If the preferred responder list field is “0”, the field is reserved.

(4) The sensing responder addresses field carries address information of a sensing responder used by the AP #1 that receives the first request frame to satisfy the request of the first AP. It may be understood that the sensing responder addresses field appears only when the preferred responder list field is set to “1”. In this case, the sensing responder addresses field includes one or more MAC addresses, and these addresses indicate STAs selected by the AP #1 to satisfy the request of the first AP.

(5) The sensing responder IDs field exists only when the preferred responder list field is set to “1” and the status code field is equal to SUCCESS. The sensing responder IDs field is used to carry ID information, for example, an association identifier (association identification, AID)/unassociated STA identifier (USID), of the sensing responder used by the AP #1 that receives the first request frame to satisfy the request of the first AP, and a ranking of the AID/USID should be the same as a ranking of the MAC address in the sensing responder addresses field.

In the foregoing technical solution, the first AP may initiate the Co-SBP request to another AP, so that the first AP can simultaneously use a plurality of sensing results, thereby avoiding a sensing task failure caused by sensing result unavailability when the first AP performs sensing alone.

It can be learned from the foregoing descriptions that, if the corresponding scenario is Scenario 2, the first STA further needs to initiate the 1^{st} Co-SBP request before the first AP initiates the 2^{nd} Co-SBP request. Optionally, before S602, the method further includes S603 and S604.

S603: The first STA sends a second request frame to the first AP, where the second request frame is used by a STA to initiate a multi-AP joint sensing by proxy request. Correspondingly, the first AP receives the second request frame from the first STA.

It should be understood that the first request frames sent by the first AP to the N APs in S601 are determined and sent based on the received second request frame.

For example, the second request frame may carry an identifier of an AP recommended by the first STA to the first AP and participating in multi-AP joint sensing. APs recommended by the first STA includes the N APs in S601, and the N APs are APs that finally participate in multi-AP joint sensing in the recommended APs.

For example, if the first STA does not recommend, to the first AP, the AP for participating in multi-AP joint sensing, the first AP may select the M (M is greater than or equal to N) APs from the multi-AP coordination set to initiate multi-AP joint sensing. The N APs in S601 are APs that finally participate in multi-AP joint sensing in the M APs.

Optionally, the second request frame includes fourth information. The fourth information indicates that the second request frame is a request frame used by the STA to initiate multi-AP joint sensing by proxy. A device that receives the second request frame may determine, based on the fourth information in the second request frame, that a device type of a device that initiates the Co-SBP request is a STA.

Optionally, the second request frame includes fifth information. The fifth information includes a parameter required for multi-AP joint sensing by proxy. For example, the parameter required for multi-AP joint sensing by proxy includes one or more of the following parameters: a multi-AP coordinated transmission model, a trigger-based sounding phase model, a number of APs required for establishing multi-AP joint sensing by proxy, whether the number of required APs is mandatory, whether an AP that receives the second request frame needs to perform sensing measurement, a number of required sensing responder STAs, whether the number of sensing responder STAs is mandatory, whether to recommend, to the AP that receives the second request frame, an AP for performing joint sensing by proxy, whether to provide different multi-AP joint sensing by proxy parameters for the recommended AP, and whether the first STA needs to participate in sensing measurement.

For example, when the fifth information indicates to provide different sensing parameters for the recommended AP, the second request frame includes sixth information. The sixth information includes a sensing parameter allocated to each AP in the recommended AP. For example, the sixth information includes one or more of the following parameters allocated to each recommended AP: a measurement parameter used for sensing, a number of required sensing responder STAs, whether the number of sensing responder STAs is mandatory, and a trigger-based sounding phase model. Meanings of the parameters are described in detail in FIG. 9 below, and are not described herein.

It should be understood that, when different sensing parameters provided for the recommended AP in the second request frame, the sensing parameter in the first request frame sent by the first AP to the AP #1 in the recommended AP is determined based on the sensing parameter of the AP #1 carried in the second request frame. For example, if the second request frame indicates that a sounding phase model that needs to be established by the AP #1 is an NDPA sounding phase, the number of sensing responder STAs required for sensing measurement by the AP #1 is 5, and the number 5 is a mandatory condition, the first request frame sent by the first AP to the AP #1 also needs to indicate that the sounding phase model that needs to be established by the AP #1 is the NDPA sounding phase, and the number of sensing responder STAs required for sensing measurement by the AP #1 is 5, and the number 5 is a mandatory condition.

Optionally, the second request frame may further include information about a type of a sensing measurement result. It should be noted that the type information in the first request frame is the same as the type information in the second request frame.

S604: The first AP sends a second response frame to the first STA, where the second response frame indicates that the multi-AP joint sensing by proxy request is accepted.

For example, the first AP may determine, based on information about the multi-AP coordination set, whether the multi-AP joint sensing request of the first STA is feasible, and reply with the second response frame based on a determining result. If the second response frame indicates that the request of the first STA is accepted, the first AP establishes multi-AP joint sensing with the N APs. For a procedure in which the first AP and the N APs establish multi-AP joint sensing, refer to the descriptions in S601 and S602. Details are not described herein again.

For example, the first AP may alternatively first establish sensing with the M APs recommended by the first STA or determined by the first AP, and then reply with the second response frame to the first STA based on a sensing establishment result. For a procedure in which the first AP and the M APs recommended by the first STA or determined by the first AP establish sensing, refer to the descriptions in S601 and S602. Details are not described herein again.

A sequence of establishing sensing with the M APs and replying with the second response frame by the first AP is not limited in this application provided that an interval between the second request frame and the second response frame does not exceed 20 ms.

Optionally, the second response frame includes seventh information. The seventh information indicates that the second response frame is a response frame responding to a multi-AP joint sensing by proxy request initiated by a STA.

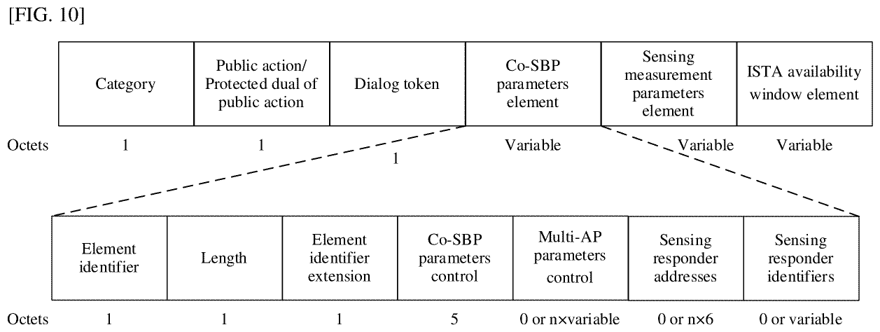

FIG. 10 is a diagram of a frame structure of a possible second request frame according to this application. The second request frame may be considered as an SBP request frame that is redesigned based on an existing SBP request frame and that is used by the STA to request multi-AP joint sensing. For example, in this application, the second request frame may be referred to as a Co-SBP request frame.

As shown in FIG. 10, the second request frame includes a category field, a public action/protected dual of public action Public Action/Protected Dual of Public Action field, a dialog token field, a Co-SBP parameters element field, a sensing measurement parameters element field, and an initiating STA (ISTA) availability window element field. The following describes some fields related to this application in the second request frame.

(1) A frame type is newly added to the existing SBP request frame for the second request frame, to indicate that the second request frame is an SBP request frame used by the STA to initiate the multi-AP joint sensing request, and indicate that the frame carries a multi-AP joint sensing parameter. For example, in this application, the frame type is extended in a public action/protected dual of public action field in the existing SBP request frame, to indicate that the frame is the second request frame. For example, as shown in Table 1, when a value of the public action/protected dual of public action field is “60” (namely, an example of the fourth information), it indicates that the current SBP request frame is the second request frame.

(2) The ISTA availability window element field in the second request frame is used by the first STA to notify the first AP of a time period in which the first STA is idle. The first AP needs to allocate the time and the cycle for multi-AP joint sensing in the idle time. This is the same as a design of existing SBP, and reuses the design herein.

(3) The sensing measurement parameters element in the second request frame indicates a sensing parameter allocated to the first AP that receives the second request frame. For example, the field includes a BW field, a max TX STS and max RX STS field, and a number of receive antennas (Number of RX Antennas) field. For meanings of the fields, refer to descriptions of corresponding fields in the sensing measurement parameters element field in the first request frame. Details are not described herein again. In a possible implementation, a design of the field may be the same as that of a sensing measurement parameters element field in the existing SBP request frame.

(4) The Co-SBP parameter element field is newly designed in the second request frame.

As shown in FIG. 10, the Co-SBP parameter element field includes an element identifier (Element ID) field, a length field, an element identifier extension (Element ID Extension) field, a Co-SBP parameters control field, a multi-AP parameters control (MAP Parameters Control) field, a sensing responder addresses field, and a sensing responder identifiers (Sensing Responder IDs) field. The following describes some fields related to this application in the Co-SBP parameter element field.

(1) The element ID field and the element ID extension field in the Co-SBP parameter element field are used to jointly indicate a type and a use scenario of a corresponding element. In this application, the element ID extension is extended to indicate that the element carries the multi-AP joint sensing parameter. In this application, an element ID, a length, and the element ID extension follow designs in IEEE 802.11bf. For example, as shown in Table 2, an element type is extended in the element ID. When a value of the element ID extension is <Last assigned+17>, it is considered that the corresponding element carries the multi-AP joint sensing parameter.

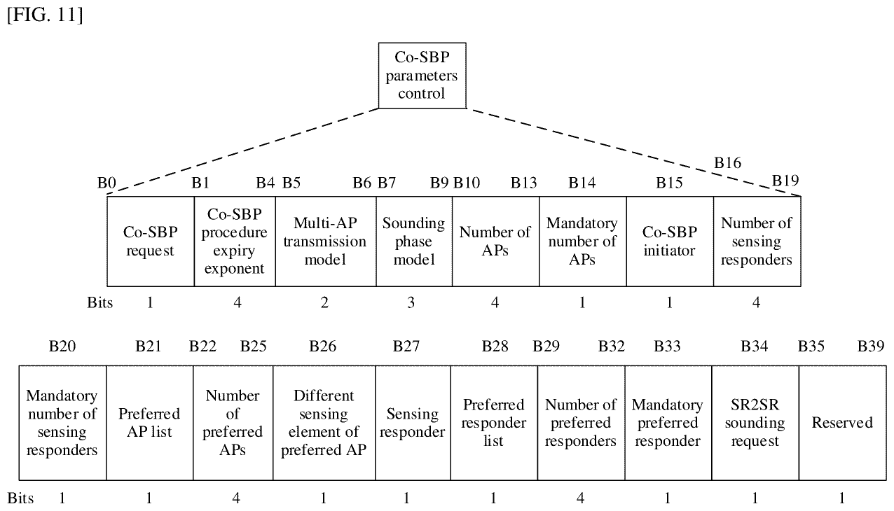

(2) The Co-SBP parameters control field in the Co-SBP parameter element field is used to carry the fifth information. For example, FIG. 11 is a diagram of a structure of the Co-SBP parameters control field. The Co-SBP parameters control field includes a Co-SBP request field, a Co-SBP procedure expiry exponent field, a multi-AP transmission model (MAP Transmission Model) field, a sounding phase model field, a number of APs field, a mandatory number of APs field, a Co-SBP initiator field, a number of sensing responders field, a mandatory number of responders field, a preferred AP list field, a number of preferred APs field, a different sensing element of preferred AP field, a sensing responder field, a preferred responder list field, a number of preferred responders field, a mandatory preferred responder field, and an SR2SR sounding request field. The following describes meanings of the fields in the Co-SBP parameters control field and parameters in the fifth information that are carried.

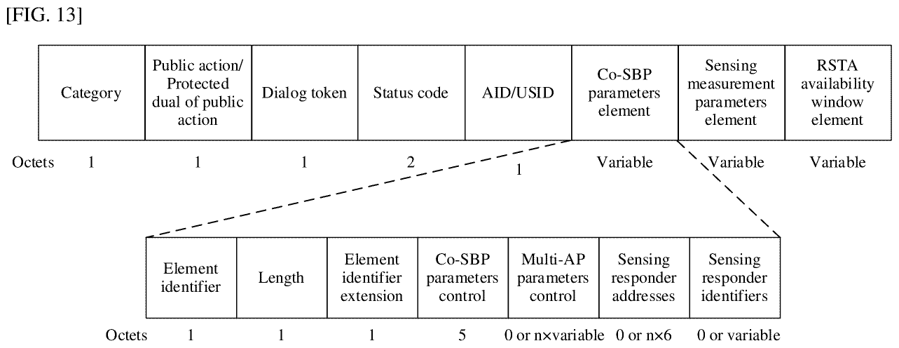

The Co-SBP request field indicates a frame in which a Co-SBP parameters element is carried. For example, the Co-SBP request field is set to “1” to indicate that the Co-SBP parameters element is carried in a request frame for multi-AP joint sensing initiated by the STA, or is set to “O” to indicate that the Co-SBP parameters element is carried in a response frame responding to multi-AP joint sensing initiated by the STA. It should be noted that, because the second request frame is a request frame for multi-AP joint sensing initiated by the STA, a value of the field in the second request frame is 1. In addition, the second response frame also includes the field (referring to FIG. 13). Because the second response frame is a response frame responding to multi-AP joint sensing initiated by the STA, the value of the field in the second response frame is 0). Because the public action/protected dual of public action field in the second request frame has indicated that the second request frame is a request frame for multi-AP joint sensing initiated by the STA, the field in the second request frame may be an optional field.

For descriptions of the Co-SBP procedure expiry exponent field, the MAP transmission model field, and the sounding phase model field, refer to descriptions of corresponding fields in the first request frame. Details are not described herein again.

However, it should be noted that a value of the co-sensing procedure expiry exponent field in the first request frame should be the same as a value of the Co-SBP procedure expiry exponent field in the second request frame. The first AP and the N APs determine, based on a same parameter value, whether the multi-AP joint sensing procedure ends. In the time window agreed on for multi-AP joint sensing, after detecting the frame on the channel through listening, the first STA and the first AP that obtain the field start to count down a duration indicated by the field. When countdown ends, if there is still no frame exchange on the channel, the first STA and the first AP consider that the current multi-AP joint sensing procedure ends.

It should be noted that the value of the MAP transmission model field in the first request frame should be the same as a value of the MAP transmission model field in the second request frame.

The number of APs field indicates a number of APs that need to be included in multi-AP joint sensing, that is, the first STA may use the number of APs field to indicate the number of APs included in multi-AP joint sensing established by the first AP.

The mandatory number of APs field indicates whether the number of APs indicated in the number of APs field is mandatory. For example, when the mandatory number of APs field is “0”, it indicates that the number of APs indicated in the number of APs field is optional. In this case, the number of APs indicated in the number of APs field is a reference quantity and should be satisfied as much as possible. On the contrary, when the mandatory number of APs field is “1”, it indicates that the number of APs indicated in the number of APs field is mandatory.

The Co-SBP initiator field indicates whether the first AP that is requested by the first STA to establish multi-AP joint sensing as a proxy needs to perform sensing measurement. For example, when the Co-SBP initiator field is “0”, it indicates that the first AP does not need to perform sensing measurement, or when the Co-SBP initiator field is “1”, it indicates that the first AP needs to perform sensing measurement.

The number of sensing responders field indicates a number of sensing responders included in sensing that needs to be established by the first AP. It should be noted that the field exists only when the co-sensing initiator field is “1”.

The mandatory number of responders field indicates whether the number of sensing responders indicated in the number of sensing responders field is mandatory.

The preferred AP list field indicates whether to provide a preferred AP list for the first AP. For example, when the preferred AP list field is “1”, it indicates to provide the preferred AP list for the first AP and carry a MAC address of the recommended AP in the MAP parameters in the second request frame, and the AP needs to search for an AP in the preferred AP list to initiate the 2^{nd} Co-SBP request: or when the preferred AP list field is “0”, it indicates not to recommend the AP list to the first AP, and the first AP searches for an appropriate AP in all the APs participating in multi-AP coordination to initiate the 2^{nd} Co-SBP request.

The number of preferred APs field indicates a number of recommended APs provided for the first AP. If the preferred AP list field is “1”, the number of preferred APs field indicates a number of MAP parameters control fields included in the Co-SBP parameters element field, where each MAP parameters control field corresponds to one recommended AP. If the preferred AP list field is “0”, the field is reserved.

The different sensing element of preferred AP field indicates whether to provide different sensing parameters for the recommended AP. It should be noted that the different sensing element of preferred AP field is meaningful only when the preferred AP list is “1”. For example, when the different sensing element of preferred AP field is “1”, it indicates to allocate the different parameter to the recommended AP: or when the different sensing element of preferred AP field is “0”, it indicates that the recommended AP uses a same parameter, and the parameter is the same as a parameter provided for the first AP.

It should be noted that, if the first STA does not recommend an AP to the first AP, the AP that is found by the first AP and that participates in multi-AP joint sensing uses a same parameter, and the parameter is the same as a parameter sent by the first STA to the first AP.

It may be understood that, if the different sensing element of preferred AP field is “0”, when the first AP needs to send the first request frame to the AP #1 in the recommended AP, the first AP generates, based on information obtained from the second request frame, the first request frame to be sent to the AP #1. For example, the frame structure of the first request frame is shown in FIG. 7. In this case, the sensing measurement parameters field in the sensing measurement parameters element field in the first request frame carries the information carried in the sensing measurement parameters field in the sensing measurement parameters element field in the second request frame, and the number of sensing responders field, the mandatory number of sensing responders field, and the sounding phase model field in the co-sensing parameters control field in the first request frame respectively carry information carried in the number of sensing responders field, the mandatory number of sensing responders field, and the sounding phase model field in the Co-SBP parameters control field in the second request frame.

The sensing responder field indicates whether the first STA participates in a sensing process of multi-AP joint sensing as a sensing responder. For example, when the sensing responder field is “0”, it indicates that the first STA does not participate in the sensing process, or when the sensing responder field is “1”, it indicates that the first STA participates in the sensing process. It may be understood that, when the sensing responder field indicates that the first STA participates in multi-AP joint sensing measurement, the co-sensing initiator field should indicate that the first AP needs to perform sensing.

For descriptions of the preferred responder list field, the number of preferred responders field, the mandatory preferred responder field, and the SR2SR sounding request field, refer to descriptions of corresponding fields in the first request frame. Details are not described herein again. It should be noted that the four fields herein are parameters allocated to the first AP, that is, the four fields are meaningful only when the co-sensing initiator field indicates that the first AP needs to perform sensing measurement: or when the co-sensing initiator field indicates that the first AP does not need to perform sensing measurement, the four fields are reserved.

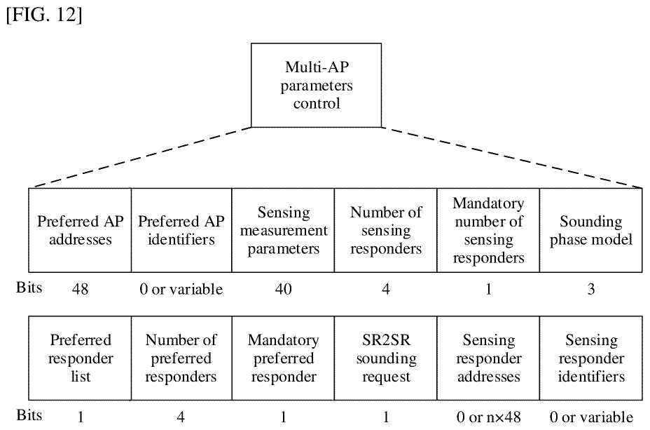

(3) The MAP parameters control field in the Co-SBP parameter element field is used to carry the sixth information. For example, FIG. 12 is a diagram of a structure of the MAP parameters control field. The MAP parameters control field includes a preferred AP addresses field, a preferred AP identifiers (Preferred AP IDs) field, a sensing measurement parameters field, a number of sensing responders field, a mandatory number of sensing responders field, a sounding phase model field, a preferred responder list field, and number of preferred responders field, a mandatory preferred responder field, an SR2SR sounding request field, a sensing responder addresses field, and a sensing responder identifiers (Sensing Responder IDs) field. The following describes meanings of the fields in the field and parameters in the sixth information that are carried.

The preferred AP addresses field is used to carry address information of the recommended AP. It may be understood that the MAP parameters control field exists in the second request frame only when the preferred AP list field is set to the recommended AP. In this case, the preferred AP addresses field in the MAP parameters control field includes one MAC address, and the address indicates a MAC address of the recommended AP. It may be understood that a preferred AP addresses field in each MAP parameters control field corresponds to one different recommended AP.

It should be noted that the preferred AP IDs field in the second request frame occupies 0 bits.

The sensing measurement parameters field is used to allocate sensing parameters to different APs. For example, the field includes a BW field, a max TX STS and max RX STS field, and a number of receive antennas (Number of RX Antennas) field. For meanings of the fields, refer to descriptions of corresponding fields in the sensing measurement parameters element field in the first request frame. Details are not described herein again. In a possible implementation, a design of the field may be the same as that of a sensing measurement parameters field in a sensing measurement parameters element in the existing SBP request frame.

The number of sensing responders field indicates a number of sensing responders (namely, sensing responder STAs) included in sensing that should be established by different recommended APs.

The mandatory number of sensing responders field indicates whether the number of sensing responders indicated in the number of sensing responders field is mandatory.

The sounding phase model field indicates a TB sounding phase model that needs to be established by an AP corresponding to an AID in a sensing phase. A design idea of the field is the same as that of the sounding phase model field in the Co-SBP parameters control field, and simply different objects are indicated by the fields.

For descriptions of the preferred responder list field, the number of preferred responders field, the mandatory preferred responder field, the SR2SR sounding request field, the sensing responder addresses field, and the sensing responder IDs field, refer to descriptions of corresponding fields in the first request frame. Details are not described herein again. It should be noted that the four fields herein are parameters allocated to the second AP, that is, the four fields are meaningful only when the different sensing element of preferred AP field indicates to provide different sensing parameters for the recommended AP: or when the different sensing element of preferred AP field indicates not to provide different sensing parameters for the recommended AP, the four fields are reserved.

It may be understood that, if the first STA allocates different sensing parameters to different recommended APs through the MAP parameters control field in the second request frame, when the first AP needs to send the first request frame to the AP #1 in the recommended AP, the first AP needs to obtain information carried in the MAP parameters control field for the AP #1 in the recommended AP, and generate, based on the information, the first request frame to be sent to the AP #1. For example, the frame structure of the first request frame is shown in FIG. 7. In this case, the sensing measurement parameters field in the sensing measurement parameters element field in the first request frame carries the sensing parameter allocated by the sensing measurement parameters field in the MAP parameters control field to the AP #1, and the number of sensing responders field, the mandatory number of sensing responders field, and the sounding phase model field in the co-sensing parameters control field in the first request frame respectively carry sensing parameters allocated by the number of sensing responders field, the mandatory number of sensing responders field, and the sounding phase model field in the MAP parameters control field to the AP #1. (4) The sensing responder addresses field in the Co-SBP parameter element field carries address information of a sensing responder recommended to the first AP. It may be understood that the sensing responder addresses field exists in the second request frame only when the preferred responder list field is set to the recommended sensing responder and the co-sensing initiator field indicates that the first AP needs to perform sensing measurement. In this case, the sensing responder addresses field includes one or more MAC addresses, and these addresses indicate MAC addresses of STAs for sensing established by the first AP.

(5) The sensing responder IDs field in the Co-SBP parameter element field occupies 0 bits.

The foregoing describes in detail the possible second request frame provided in FIG. 10. For example, the following describes a frame structure of a possible second response frame with reference to FIG. 13.

FIG. 13 is a diagram of the frame structure of the possible second response frame according to this application. For example, in this application, the second response frame may be referred to as a Co-SBP response frame. As shown in FIG. 13, the frame structure of the second response frame is basically the same as that of the second request frame. The second response frame includes a category field, a public action/protected dual of public action field, a dialog token field, a status code field, an AID/USID field, a Co-SBP parameters element field, a sensing measurement parameters element field, and an RSTA availability window element field. Herein, only fields that carry different information in the second response frame and the second request frame are described.

(1) A frame type is extended in the public action/protected dual of public action field in the second response frame, to indicate that the second response frame is a response frame responding to a multi-AP joint sensing by proxy request initiated by a STA. For example, as shown in Table 1, when a value of the public action/protected dual of public action field is 61 (namely, an example of the seventh information), it indicates that the second response frame is a response frame responding to a multi-AP joint sensing by proxy request initiated by a STA.

(2) The status code field in the second response frame indicates whether the first AP accepts the request of the second request frame. For an example of the field, refer to the foregoing descriptions. Details are not described herein again.

It should be noted herein that, if the status code field is equal to SUCCESS and the first STA is associated with the first AP, the AID/USID field is set to an AID of the first STA: or if the status code field is equal to SUCCESS and the first STA is not associated with the first AP, the AID/USID field is set to a USID of the first STA.

(3) The Co-SBP parameter element field is newly defined in the second response frame. A design of the Co-SBP parameter element field in the second response frame is the same as that of the Co-SBP parameter element field in the second request frame, and only meanings of some fields are different. The following describes only the fields whose meanings are different.

(1) If a Co-SBP request field in a Co-SBP parameter control field in the Co-SBP parameters element field in the second response frame exists, for example, when a value of the Co-SBP request field is 1, it indicates that a Co-SBP parameters element is carried in the request frame for multi-AP joint sensing initiated by the STA, or when the value is 0, it indicates that the Co-SBP parameters element is carried in the response frame responding to multi-AP joint sensing initiated by the STA. In this case, the value of the field in the second response frame needs to be set to 0, to indicate that the Co-SBP parameters element is carried in the second response frame. Because the public action/protected dual of public action field in the second response frame has indicated that the second response frame is a response frame responding to multi-AP joint sensing initiated by the STA, the field in the second response frame may be an optional field.

(2) The Co-SBP procedure expiry exponent field, the MAP transmission model field, the sounding phase model field, the mandatory number of APs field, the co-sensing initiator field, the mandatory number of responders field, the sensing responder field, the mandatory preferred responder field, the SR2SR sounding request field, and the different sensing element of preferred AP field are reserved in the second response frame.

(3) A number of APs field has different meanings based on a variation of the status code field. For example, if the status code field in the second response frame is equal to SUCCESS, the number of APs field indicates a number of APs included in multi-AP joint sensing that is actually established by the AP that receives the second request frame. If the status code field in the second response frame is equal to REJECTED_WITH_SUGGESTED_CHANGES, the number of APs field is used to suggest a value of the field carried in the second request frame when the first STA initiates multi-AP joint sensing next time.

(4) A number of sensing responders field has different meanings based on the variation of the status code field. For example, if the status code field in the second response frame is equal to SUCCESS, the number of sensing responders field indicates a number of sensing responders included in sensing that is actually established by the AP that receives the second request frame. If the status code field in the second response frame is equal to REJECTED_WITH_SUGGESTED_CHANGES, the number of sensing responders field is used to suggest a value of the field carried in the second request frame when the first STA initiates multi-AP joint sensing next time. It should be noted that the field exists in the second response frame only when the field exists in the second request frame.

(5) A preferred AP list field indicates whether to carry, in a MAP parameters control field, an AID of an AP included in sensing established by the first AP or a MAC address of an AP recommended by the first AP to a STA 4. In other words, the field indicates whether the MAP parameters control field exists. For example, when the preferred AP list field is “1”, it indicates that the MAP parameters control field exists: or when the preferred AP list field is “0”, it indicates that the MAP parameters control field does not exist. In a possible implementation, a design of the field may be the same as that of a preferred AP list field in an existing SBP response frame.

(6) A number of preferred AP list field indicates a number of MAP parameters control fields included. For example, if the preferred AP list field is “1”, the number of preferred AP field indicates the number of MAP parameters control fields included, where one MAP parameters control field corresponds to one recommended AP. If the preferred AP list field is “0”, the field is reserved.

(7) A number of preferred responders field indicates a number of MAC addresses included in a sensing responder addresses field. For example, if the preferred responder list field is “1”, the number of preferred responders field indicates MAC addresses of a number of sensing responders included in the sensing responder addresses field. If the preferred responder list field is “0”, the field is reserved.

(4) The MAP parameters control field is newly defined in the second response frame. A design of the MAP parameters control field in the second response frame is the same as that of the MAP parameters control field in the second request frame, and only meanings of some fields are different. The following describes only the fields whose meanings are different.

(1) A preferred AP addresses field carries address information of the second AP used by the first AP to satisfy the request of the first STA. It may be understood that the preferred AP addresses field exists in the second response frame only when the preferred AP list field is set to “1”. In this case, the preferred AP addresses field includes one MAC address, and the address indicates a MAC address of the second AP. It may be understood that a preferred AP addresses field in each MAP parameters control field corresponds to one different second AP.

(2) A preferred AP IDs field exists only when the preferred AP list field is set to “1” and the status code field is equal to SUCCESS. The preferred AP IDs field is used to carry ID information, for example, an AID/USID, of the second AP used by the first AP to satisfy the request of the first STA. The AID/USID may be negotiated between APs or may be an ID that is generated based on a MAC address of an AP and that has a length of 12 bits. A method for obtaining the AID/USID is not limited in this application provided that the AID/USID is obtained by using the conventional technology and can indicate a corresponding AP. It should be noted that an AID/USID in a same MAP parameters control field and a MAC address in the preferred AP addresses field should indicate a same second AP.

(5) The sensing responder addresses field carries address information of a sensing responder used by the first AP to satisfy the request of the first STA. It may be understood that the sensing responder addresses field appears only when the co-sensing initiator field is set to “1” and the preferred responder list field is set to “1”. In this case, the sensing responder addresses field includes one or more MAC addresses, and these addresses indicate a sensing responder selected by the first AP to satisfy the request of the first STA.

(6) A sensing responder IDs field exists only when the co-sensing initiator field is set to “1”, the preferred responder list field is set to “1”, and the status code field is equal to SUCCESS. The sensing responder IDs field is used to carry the ID information, for example, the AID/USID, of the sensing responder used by the first AP to satisfy the request of the first STA, and a ranking of the AID/USID should be the same as a ranking of the MAC address in the sensing responder addresses field.

It should be noted that, in Scenario 2, information about the time window that is allocated by the first AP in the first request frame and that is used for multi-AP joint sensing should be the same as information that is carried in the second response frame replied by the first AP to the first STA and that is about a time window for multi-AP joint sensing. For example, the information about the time window for multi-AP joint sensing may be carried in the RSTA availability window element field in the second response frame shown in FIG. 13.

It may be understood that, in Scenario 1, S601 and S602 may be referred to as a multi-AP joint sensing establishment phase in this scenario, and in Scenario 2, S601 to S604 may be referred to as a multi-AP joint sensing establishment phase in this scenario. With reference to accompanying drawings, the following uses examples to describe frame exchange procedures in the multi-AP joint sensing establishment phases in two scenarios.

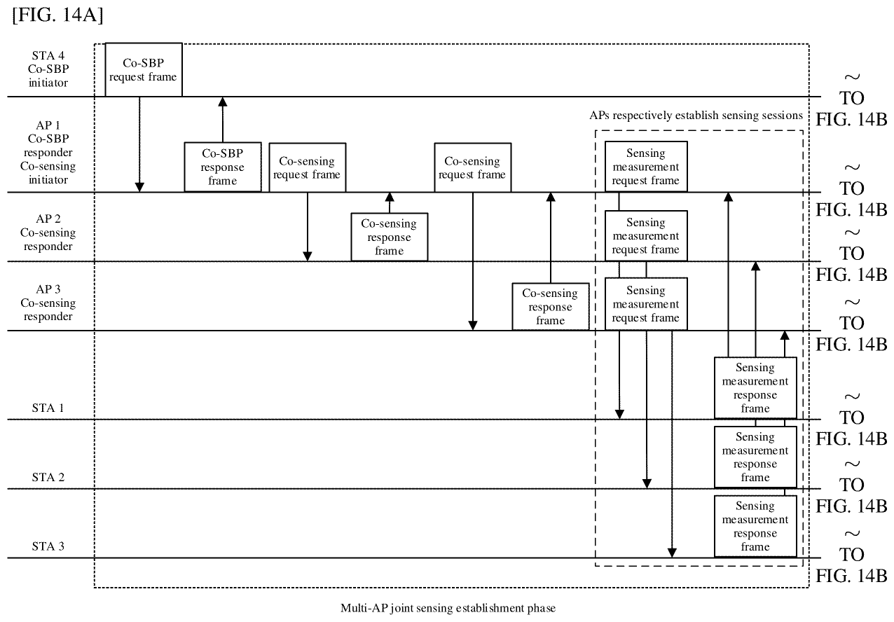

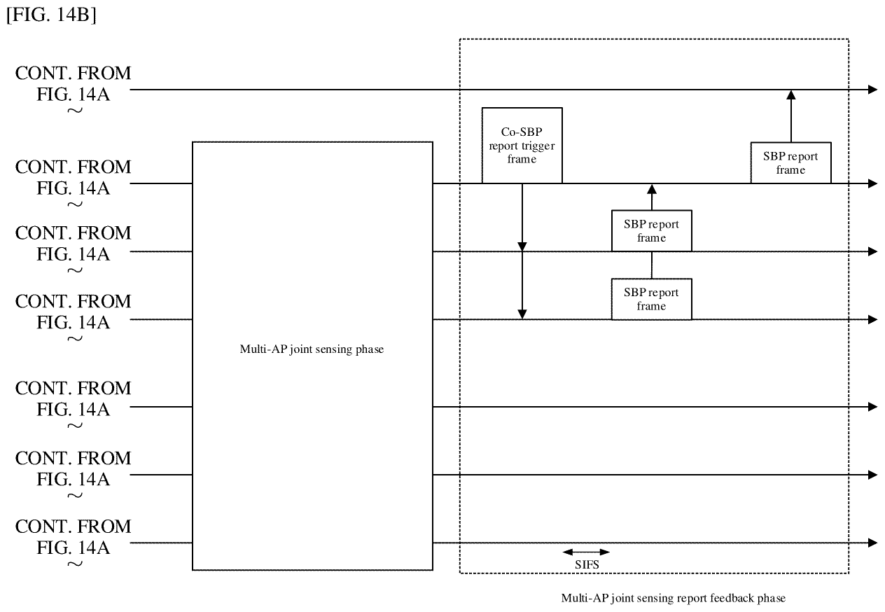

FIG. 14A and FIG. 14B are a diagram of a multi-AP joint sensing procedure corresponding to Scenario 1. FIG. 14A and FIG. 14B include the multi-AP joint sensing establishment phase, a multi-AP joint sensing measurement phase, and a multi-AP joint sensing report feedback phase in Scenario 1. An AP 1 may be considered as the first AP, and an AP 2 and an AP 3 may be considered as APs in the NAPs. In this scenario, the AP 1, as a co-sensing initiator, sends a co-sensing request frame (namely, an example of the first request frame) to the AP 2 to initiate the multi-AP joint sensing request. The AP 2, as a co-sensing responder, sends a co-sensing response frame (namely, an example of the first response frame) to the AP 1 to indicate that the multi-AP joint sensing request initiated by the AP 1 is accepted. Then, the AP 1, as the co-sensing initiator, continues to send a co-sensing request frame (namely, an example of the first request frame) to the AP 3 to initiate the multi-AP joint sensing request. The AP 3, as a co-sensing responder, sends a co-sensing response frame (namely, an example of the first response frame) to the AP 1 to indicate that the multi-AP joint sensing request initiated by the AP 1 is accepted. Finally, the AP 1, the AP 2, and the AP 3 respectively send sensing measurement request frames to a STA 1, a STA 2, and a STA 3 associated with the AP 1, the AP 2, and the AP 3 to establish sensing sessions, to prepare for subsequent multi-AP sensing measurement. The STA 1, the STA 2, and the STA 3 respectively send sensing measurement response frames to the AP 1, the AP 2, and the AP 3 to indicate that the sensing sessions are established. Then, the APs participating in multi-AP joint sensing may continue to complete corresponding frame exchange in the multi-AP joint sensing measurement phase and the multi-AP joint sensing report feedback phase. Procedures of the two phases are described in detail in S605 to S607, and are not described herein.

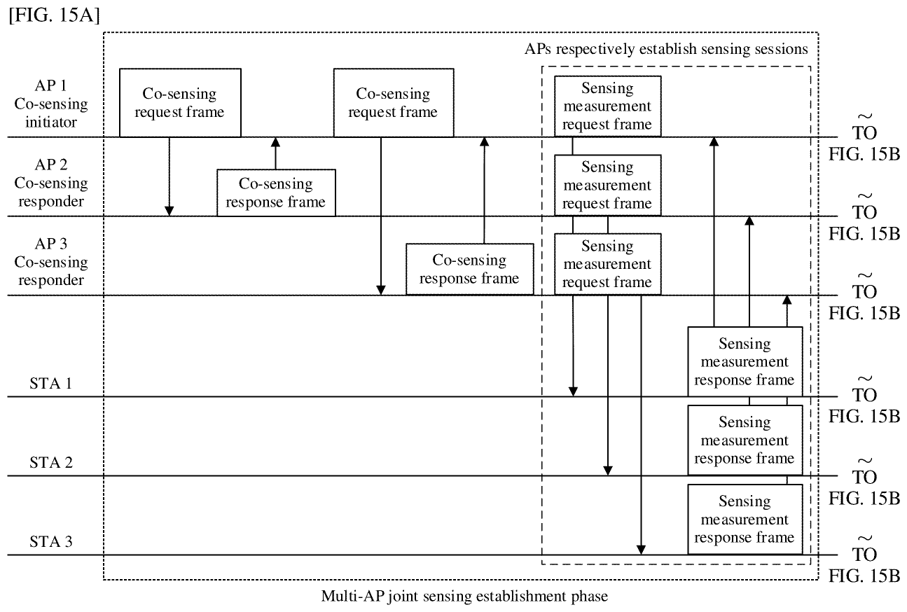

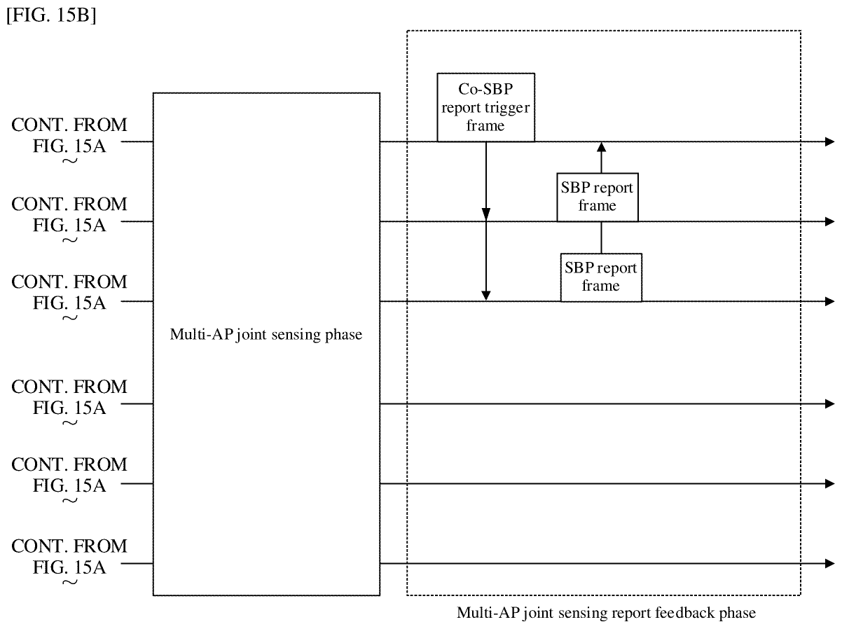

FIG. 15A and FIG. 15B are a diagram of a multi-AP joint sensing procedure corresponding to Scenario 2. FIG. 15A and FIG. 15B include the multi-AP joint sensing establishment phase, a multi-AP joint sensing measurement phase, and a multi-AP joint sensing report feedback phase in Scenario 2. An STA4 be considered as the first STA, an AP 1 may be considered as the first AP, and an AP 2 and an AP 3 may be considered as APs in the N APs. The multi-AP joint sensing measurement phase and the multi-AP joint sensing report feedback phase are described in detail in S605 to S607, and are not described herein. In this scenario, the STA 4, as a Co-SBP initiator, sends a Co-SBP request frame (namely, an example of the second request frame) to the AP 1 to initiate the multi-AP joint sensing request. The AP 1, as a Co-SBP responder, sends a Co-SBP response frame (namely, an example of the second response frame) to the STA 4 to indicate that the multi-AP joint sensing request initiated by the STA 4 is accepted. Then, the AP 1, as a co-sensing initiator, sends a co-sensing request frame (namely, an example of the first request frame) to the AP 2 to initiate the multi-AP joint sensing request. The AP 2, as a co-sensing responder, sends a co-sensing response frame (namely, an example of the first response frame) to the AP 1 to indicate that the multi-AP joint sensing request initiated by the AP 1 is accepted. Then, the AP 1, as the co-sensing initiator, continues to send a co-sensing request frame (namely, an example of the first request frame) to the AP 3 to initiate the multi-AP joint sensing request. The AP 3, as a co-sensing responder, sends a co-sensing response frame (namely, an example of the first response frame) to the AP 1 to indicate that the multi-AP joint sensing request initiated by the AP 1 is accepted. Finally, the AP 1, the AP 2, and the AP 3 respectively send sensing measurement request frames to a STA 1, a STA 2, and a STA 3 associated with the AP 1, the AP 2, and the AP 3 to establish sensing sessions. The STA 1, the STA 2, and the STA 3 respectively send sensing measurement response frames to the AP 1, the AP 2, and the AP 3 to indicate that the sensing sessions are established. Then, the APs participating in multi-AP joint sensing may continue to complete corresponding frame exchange in the multi-AP joint sensing measurement phase and the multi-AP joint sensing report feedback phase. A procedure of the multi-AP joint sensing measurement phase is described in detail in S605, and a procedure of the multi-AP joint sensing report feedback phase is described in detail in S605 to S608. Details are not described herein.

Optionally, after the N APs successfully establish sensing sessions with the associated STAs, the method further includes the following steps.

S605: The first AP triggers the N APs to perform multi-AP joint sensing measurement. The following provides two implementations in which the first AP triggers the N APs to perform sensing measurement.

In Implementation 1, the first AP may sequentially trigger the N APs to perform sensing measurement. For example, if the second AP in the N APs is not a last AP in the N APs that is triggered to perform sensing measurement, that the first AP triggers the N APs to perform multi-AP joint sensing measurement includes: The first AP determines that the second AP completes sensing measurement: the first AP sends a first polling trigger frame to a third AP in the N APs, where the first polling trigger frame is used to trigger the third AP to perform sensing measurement, and the third AP is any AP in the N APs that is not triggered to perform sensing measurement; and the first AP receives a first polling acknowledgment frame from the third AP. Optionally, ninth information in the first polling trigger frame is used to trigger an AP that receives the first polling trigger frame to perform multi-AP joint sensing measurement.

Optionally, the first polling trigger frame includes tenth information. The tenth information indicates the third AP to start to perform sensing measurement.

Examples are used to describe manners in which the first AP determines that an AP (for example, the third AP) in the N APs completes sensing measurement in this implementation. Example 1: The first polling trigger frame includes information #1, and the information #1 includes a duration in which the third AP performs sensing measurement. When the first AP allocates the duration to the third AP, the third AP needs to complete sensing measurement within the allocated duration. After the duration allocated to the third AP expires, the first AP continues to trigger a next AP to perform sensing measurement. Example 2: The first polling trigger frame does not include a duration in which the third AP performs sensing measurement. In this case, after the first AP triggers the third AP to perform sensing measurement, the third AP may complete sensing measurement with a corresponding STA. The first AP continuously monitors a channel. When the channel is idle, the first AP considers that the third AP completes sensing measurement, and continues to trigger a next AP to perform sensing measurement.

In Implementation 2, the first AP can allocate, to each AP in the N APs, a sensing measurement start time and a duration for performing sensing measurement, and the N APs perform sensing measurement based on the sensing measurement start times and the durations of the N APs. For example, that the first AP triggers the N APs to perform multi-AP joint sensing measurement includes: The first AP sends a second polling trigger frame to the N APs, where the second polling trigger frame is used to trigger the N APs to respectively perform sensing measurement based on the respective corresponding sensing measurement start times and durations; and the first AP receives second polling acknowledgment frames of the N APs, where the second polling acknowledgment frame indicates that an AP confirms to perform sensing measurement based on a corresponding sensing measurement start time and a corresponding duration.

Optionally, the second polling trigger frame includes eighth information. The eighth information includes the start times and the durations for the N APs to perform sensing measurement.

Optionally, eleventh information in the second polling trigger frame is used to trigger the N APs to perform multi-AP joint sensing measurement.

Optionally, the second polling trigger frame includes twelfth information. The twelfth information indicates the N APs to perform sensing measurement based on the respective corresponding sensing measurement start times and durations.

Current SBP does not support an SBP initiator in controlling the sensing process. Even if the first AP can initiate the multi-AP joint request, it cannot be ensured that a plurality of sensing results can be used in combination. However, based on the method provided in S605, the first AP can control sensing measurement of the plurality of APs, so that the plurality of APs complete sensing on the target in a short time period. In this case, sensing results of all the APs may be considered as soft-synchronized, to ensure that the plurality of sensing results can be used in combination. In this case, when the sensing result of the first AP is unavailable due to a reason like interference or excessively weak signal strength on a BSS edge, the sensing results of the N APs at “a same moment” may be used, thereby avoiding the sensing task failure.

For example, the foregoing polling trigger frame used to trigger multi-AP joint sensing, for example, the first polling trigger frame or the second polling trigger frame, may be referred to as a Co-SBP polling trigger frame in this application.

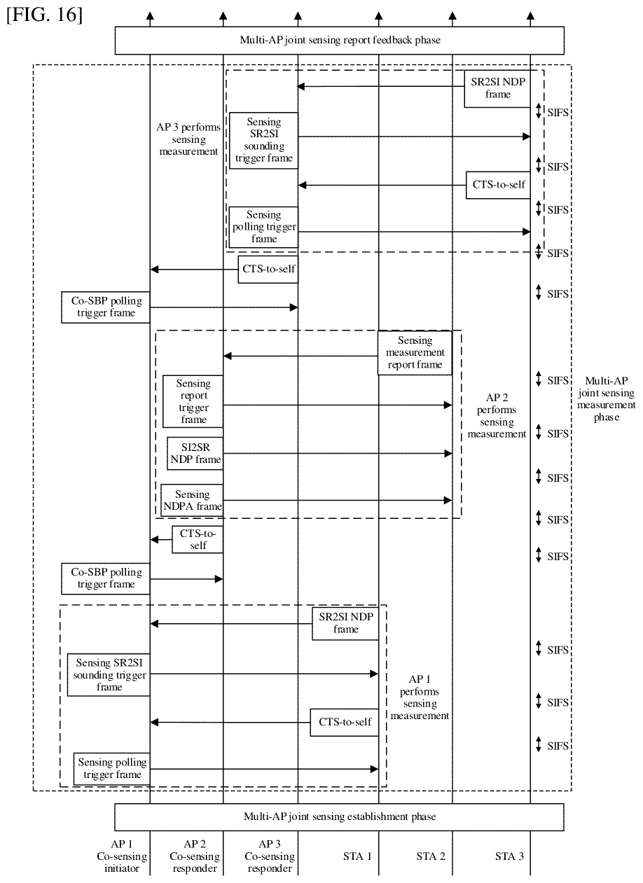

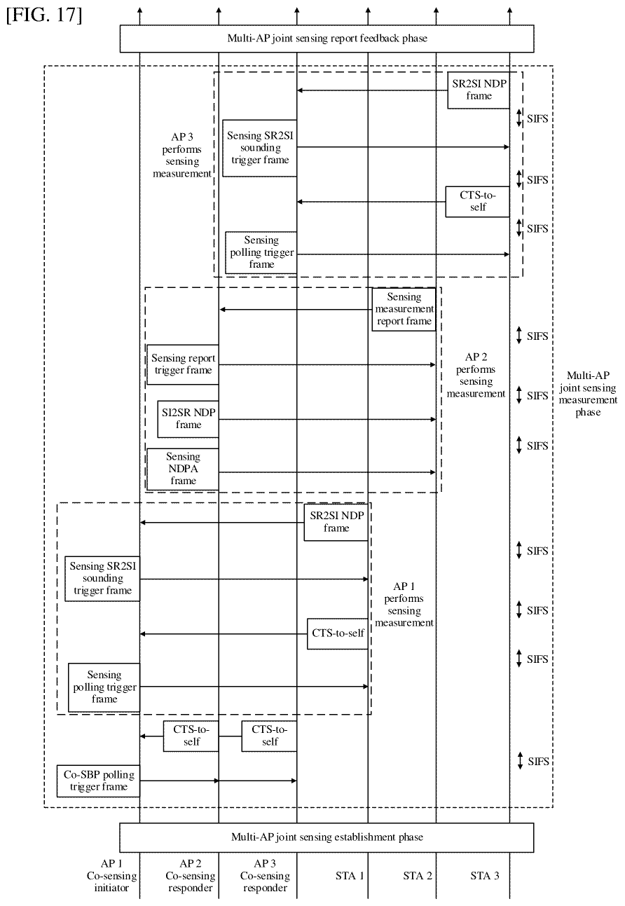

With reference to FIG. 16 and FIG. 17, the following uses examples to describe Implementation 1 and Implementation 2.

FIG. 16 is a diagram in which the plurality of APs perform joint sensing based on Implementation 1. The AP 1 may be considered as the first AP, and the AP 2 and the AP 3 may be considered as the APs in the N APs. As shown in FIG. 16, the AP 1 first performs sensing measurement. After completing sensing measurement, the AP 1 sends a Co-SBP polling trigger frame to the AP 2 to trigger the AP 2 to perform measurement sensing. The AP 2 sends a CTS-to-self frame to the AP 1 in response. Then, the AP 2 starts sensing measurement. After determining that the AP 2 completes sensing measurement, the AP 1 sends the Co-SBP polling trigger frame to the AP 3 to trigger the AP 3 to perform measurement sensing. The AP 3 sends a CTS-to-self frame to the AP 1 in response. Then, the AP 3 starts sensing measurement, until all the APs participating in multi-AP sensing measurement complete sensing measurement based on the Co-SBP polling trigger frame sent by the AP 1.

FIG. 17 is a diagram in which the plurality of APs perform joint sensing based on Implementation 2. The AP 1 may be considered as the first AP, and the AP 2 and the AP 3 may be considered as the APs in the N APs. As shown in FIG. 17, the AP 1 sends a Co-SBP polling trigger frame to the AP 2 and the AP 3 to trigger the AP 2 and the AP 3 to perform measurement sensing. The Co-SBP polling trigger frame includes a start time and a duration for the AP 2 to perform sensing measurement and a start time and a duration for the AP 3 to perform sensing measurement. The AP 2 and the AP 3 send CTS-to-self frames to the AP 1 in response. The AP 1, the AP 2, and the AP 3 sequentially perform sensing measurement based on respective sensing measurement start times and durations.

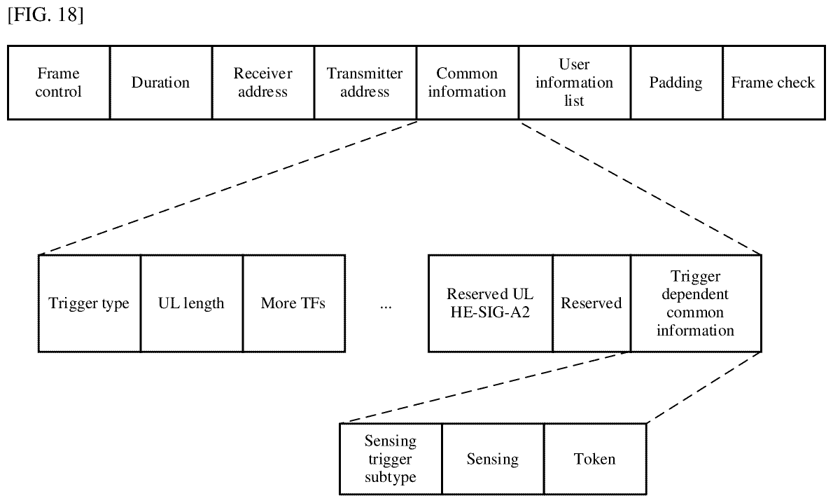

FIG. 18 is a diagram of a frame structure of a possible polling trigger frame (referred to as a Co-SBP polling trigger frame below as an example) used to trigger multi-AP joint sensing according to this application. The polling trigger frame used to trigger multi-AP joint sensing may be considered as a polling trigger frame that is redesigned based on an existing trigger frame and that is used for multi-AP joint sensing. The existing trigger frame cannot support a function of triggering sensing measurement of the plurality of APs in this application, but the polling trigger frame provided in FIG. 18 can support a multi-AP joint sensing scenario in this application. In this application, only a trigger dependent common information field and a user info field in a common information field in the existing trigger frame are modified.

As shown in FIG. 18, the Co-SBP polling trigger frame includes fields such as a common information field and a user information list field. The common information field includes common information that needs to be read by all the STAs associated with the APs. The user information list field includes a plurality of user information fields. Each user information field corresponds to information that needs to be read by one STA. The following describes some fields related to this application in the Co-SBP polling trigger frame.

(1) A frame type is newly added to the existing trigger frame for the Co-SBP polling trigger frame, to indicate that the Co-SBP polling trigger frame is a polling trigger frame used to trigger multi-AP joint sensing. For example, in this application, the frame type is extended in a sensing trigger subtype field in the trigger dependent common info field in the common info field in the existing trigger frame, to indicate that the trigger frame is a Co-SBP polling trigger frame. For example, as shown in Table 3, when a value of the sensing trigger subtype field is 5 (namely, an example of the ninth information or an example of the eleventh information), it indicates that the current trigger frame is a Co-SBP polling trigger frame, and an AP that receives the frame needs to return a CTS-to-self frame for response.

TABLE 3

| Value of the sensing | |
|---|---|
| trigger subtype field | Meaning |
| . . . | . . . |
| 3 | Sensing report |
| 4 | SR2SI sounding |
| 5 | Co-SBP polling |
| 6 | Co-SBP report |
| 7 to 15 | Reserved |

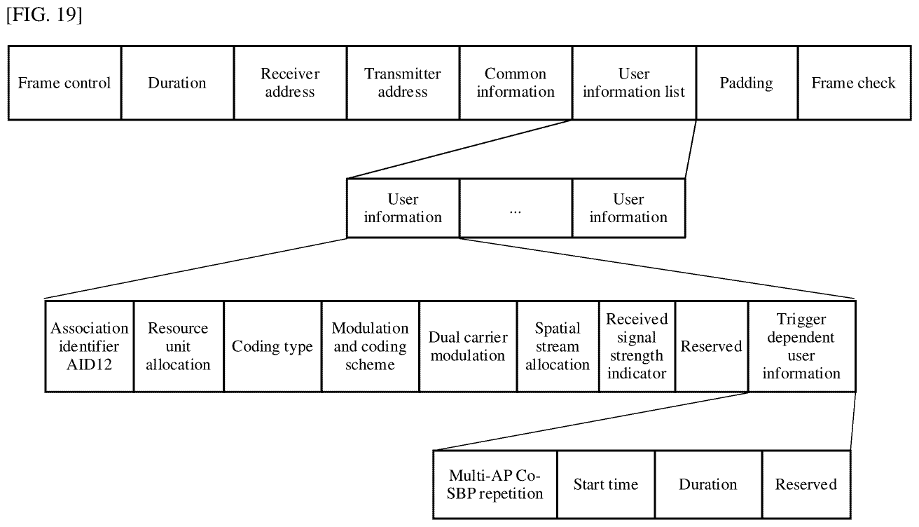

(2) A trigger dependent user information field in the user info list field in the Co-SBP polling trigger frame is used to carry parameters allocated to different APs and required for sensing measurement. The parameters include the eighth information. For example, when the value of the sensing trigger subtype field in the trigger frame is 5, it is considered that the trigger frame is a Co-SBP polling trigger frame, and the user info list field in the Co-SBP polling trigger frame carries the trigger dependent user info field. For example, FIG. 19 is a diagram of a structure of the user info list field. The user info list field includes the plurality of user info fields. Each user info field includes an AID12 field and a trigger dependent user info field. The AID12 field indicates an association identifier of one AP. The trigger dependent user info field indicates a number of repetitions of an HE-LTF in an NDP frame sent by the AP indicated by the AID12 field in a sounding phase, and a start time and a duration for sensing measurement of the AP indicated by the AID12 field.

As shown in FIG. 19, the trigger dependent user info field includes a Co-SBP repetition (Co-SBP Rep) field, a start time field, and a duration field. The following describes meanings of the fields in the trigger dependent user info field and parameters that are carried.

The Co-SBP rep field indicates the number of repetitions of the HE-LTF in the NDP frame sent by the AP corresponding to the AID12 in the sounding phase.

The start time field indicates a first duration. The first duration is used to determine an expected start time at which the AP corresponding to the AID12 performs sensing measurement. For example, the expected start time may be a corresponding time when the first duration elapses after the Co-SBP polling trigger frame is received.

The duration field indicates a duration of sounding of the AP corresponding to the AID12. If the field is configured, each AP should complete sounding within the duration. The duration may be a specified duration at a granularity of 32 μs. For example, a value of the field in a corresponding Co-SBP polling trigger frame in Implementation 1 may be set to 0.

Optionally, an AP that receives the Co-SBP polling trigger frame may determine, based on a number of user info fields carried in the Co-SBP polling trigger frame, to perform sensing measurement based on Implementation 1 or Implementation 2. In Implementation 1, the Co-SBP polling trigger frame carries only one user info field (namely, user info of the triggered AP). In Implementation 2, the Co-SBP polling trigger frame carries the plurality of user info fields (namely, user info of all the triggered APs). Therefore, the AP may determine, based on the number of user info fields included in the Co-SBP polling trigger frame, to perform subsequent sensing measurement based on Implementation 1 or Implementation 2.

Optionally, the trigger dependent user info field may further include a model field. The field indicates the AP corresponding to the AID12 to perform sensing measurement based on Implementation 1 or Implementation 2. For example, the field is indicated by using 1 bit. When a value of the field is 0, it indicates that the AP starts to perform sensing measurement (namely, Implementation 1). When the value of the field is 1, it indicates that the AP performs sensing measurement based on the corresponding sensing measurement start time and duration (namely, Implementation 2).

For example, when the AP #1 in the N APs determines, based on the first polling trigger frame, to perform measurement based on Implementation 1, the AP #1 may not read a start time field in the first polling trigger frame. When the AP #1 determines, based on the second polling trigger frame, to perform measurement based on Implementation 2, the AP #1 needs to read values of a start time field and a duration field in a user info field that includes an AID of the AP #1 in the second polling trigger frame.

For example, when the first AP triggers, through a polling trigger frame #1, the AP Clean Specification #1 to perform measurement based on Implementation 1, and the first AP does not indicate, to the AP #1, a duration for performing sensing measurement, the duration field in the first trigger frame may be set to 0.

It may be understood that, in this application, S605 may be referred to as a multi-AP joint sensing phase.

Optionally, after sensing measurement of the N APs ends, if the multi-AP joint sensing scenario is Scenario 1, the method further includes S606 and S607. If the multi-AP joint sensing scenario is Scenario 2, the method further includes S606 to S608.

S606: The first AP sends a first report trigger frame to the N APs, where the first report trigger frame is used to trigger the N APs to report multi-AP joint sensing measurement results.

Optionally, thirteenth information in the first report trigger frame is used to trigger an AP that receives the first report trigger frame to report a multi-AP joint sensing measurement result.

Optionally, the first report trigger frame includes type information of the sensing measurement result. The type information includes the one or more types in the first request frame. The N APs report the corresponding measurement results based on the type information.

For example, the first report trigger frame in this application may be referred to as a Co-SBP report trigger frame.

Optionally, the Co-SBP report trigger frame may reuse an existing sensing report trigger frame, and only a trigger frame type needs to be added to the sensing report trigger frame, to indicate that the Co-SBP report trigger frame is a trigger frame used to trigger reporting of the multi-AP joint sensing result, and indicate that the AP that receives the frame needs to return an SBP report frame in an uplink manner after an interval of SIFS time. For example, in this application, the frame type is extended in a sensing trigger subtype field in a Trigger Dependent Common info field in a common info field in the existing sensing report trigger frame, to indicate that the trigger frame is a Co-SBP report trigger frame. For example, as shown in Table 3, when a value of the sensing trigger subtype field is 6 (namely, an example of the thirteenth information), it indicates that the current trigger frame is a Co-SBP report trigger frame.

S607: The N APs respectively send the measurement results to the first AP. Correspondingly, the first AP receives the measurement results from the N APs.

S608: The first AP sends the measurement results of the N APs to the first STA. Correspondingly, the first STA receives the sensing measurement results of the N APs from the first AP.

It may be understood that, in this application, S605 to S608 may be referred to as a multi-AP joint sensing report feedback phase.

It should be understood that sequence numbers of the foregoing processes do not mean an execution sequence. The execution sequence of the processes should be determined based on functions and internal logic of the processes, and should not be construed as any limitation on implementation processes of embodiments of this application.

It should be further understood that, in embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

It should be further understood that, in some of the foregoing embodiments, a device in an existing network architecture is mainly used as an example for description. It should be understood that, a specific form of the device is not limited in embodiments of this application. For example, all devices that can implement a same function in the future are applicable to embodiments of this application.

It may be understood that, in the foregoing method embodiments, the method and the operation implemented by the device (for example, the foregoing co-sensing responder or co-sensing initiator) may alternatively be implemented by a component (for example, a chip or a circuit) of the device.

The foregoing describes in detail the method provided in embodiments of this application with reference to FIG. 1 to FIG. 19. The foregoing method is mainly described from a perspective of interaction between the co-sensing initiator and the co-sensing responder. It may be understood that, to implement the foregoing functions, the co-sensing initiator and the co-sensing responder include corresponding hardware structures and/or software modules for performing the functions.

A person skilled in the art should be aware that, in combination with units and algorithm steps of the examples described in embodiments disclosed in this specification, this application can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

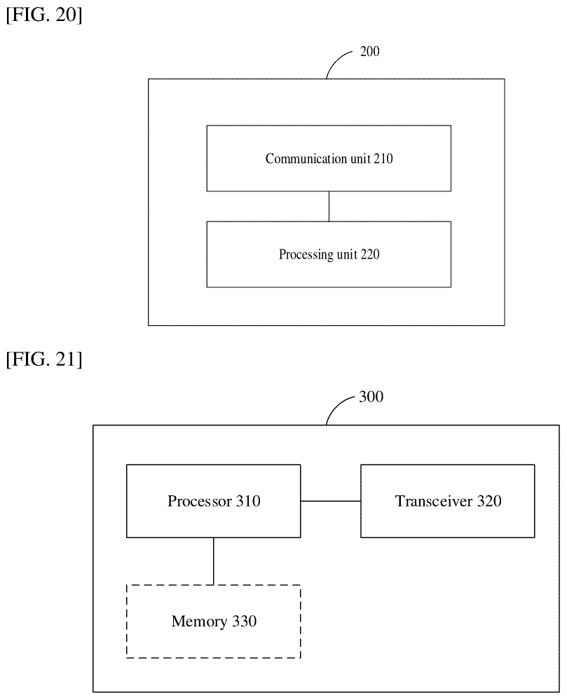

With reference to FIG. 20 and FIG. 21, the following describes in detail communication apparatuses provided in embodiments of this application. It should be understood that descriptions of apparatus embodiments correspond to the descriptions of the method embodiments. Therefore, for content that is not described in detail, refer to the foregoing method embodiments. For brevity, some content is not described again. In embodiments of this application, the co-sensing initiator or the co-sensing responder may be divided into functional modules based on the foregoing method examples. For example, each functional module may be obtained through division based on each corresponding function, or two or more functions may be integrated into one processing module. The integrated module may be implemented in a form of hardware, or may be implemented in a form of a software functional module. It should be noted that, in embodiments of this application, division into the modules is an example, is merely logical function division, and may be other division during actual implementation. The following uses an example in which each functional module is obtained through division based on each corresponding function for description.

The foregoing describes in detail the data transmission method provided in this application. The following describes the communication apparatuses provided in this application. In a possible implementation, the apparatus is configured to implement the steps or the procedures corresponding to the co-sensing responder in the foregoing method embodiments. In another possible implementation, the apparatus is configured to implement the steps or the procedures corresponding to the co-sensing initiator in the foregoing method embodiments.

FIG. 20 is a block diagram of a communication apparatus 200 according to an embodiment of this application. As shown in FIG. 20, the apparatus 200 may include a communication unit 210 and a processing unit 220. The communication unit 210 may communicate with the outside, and the processing unit 220 is configured to process data. The communication unit 210 may also be referred to as a communication interface or a transceiver unit.

In a possible design, the apparatus 200 may implement the steps or the procedures performed by the co-sensing initiator in the foregoing method embodiments. The processing unit 220) is configured to perform processing-related operations of the co-sensing initiator in the foregoing method embodiments, and the communication unit 210 is configured to perform sending-related operations of the co-sensing initiator in the foregoing method embodiments.

In another possible design, the apparatus 200 may implement the steps or the procedures performed by the co-sensing responder in the foregoing method embodiments. The communication unit 210 is configured to perform receiving-related operations of the co-sensing responder in the foregoing method embodiments, and the processing unit 220 is configured to perform processing-related operations of the co-sensing responder in the foregoing method embodiments.

It should be understood that the apparatus 200 herein is embodied in a form of a functional unit. The term “unit” herein may be an application-specific integrated circuit (ASIC), an electronic circuit, a processor (for example, a shared processor, a dedicated processor, or a group processor) configured to execute one or more software or firmware programs, a memory, a merged logic circuit, and/or another appropriate component that supports the described function. In an optional example, a person skilled in the art may understand that the apparatus 200 may be the co-sensing initiator in the foregoing embodiments, and may be configured to perform the procedures and/or the steps corresponding to the co-sensing initiator in the foregoing method embodiments; or the apparatus 200 may be the co-sensing responder in the foregoing embodiments, and may be configured to perform the procedures and/or the steps corresponding to the co-sensing responder in the foregoing method embodiments. To avoid repetition, details are not described herein again.

The apparatus 200 in each of the foregoing solutions has functions of implementing the corresponding steps performed by the co-sensing initiator in the foregoing method, or the apparatus 200 in each of the foregoing solutions has functions of implementing the corresponding steps performed by the co-sensing responder in the foregoing method. The function may be implemented by hardware, or may be implemented by hardware executing corresponding software. The hardware or the software includes one or more modules corresponding to the foregoing function. For example, the communication unit may be replaced with a transceiver (for example, a sending unit in the communication unit may be replaced with a transmitter, and a receiving unit in the communication unit may be replaced with a receiver), and another unit like the processing unit may be replaced with a processor, to respectively perform the sending/receiving operations and the processing-related operations in the method embodiments.

In addition, the communication unit may alternatively be a transceiver circuit (for example, may include a receiving circuit and a sending circuit), and the processing unit may be a processing circuit. In this embodiment of this application, the apparatus in FIG. 20 may be the co-sensing responder or the co-sensing initiator in the foregoing embodiments, or may be a chip or a chip system, for example, a system on chip (SoC). The communication unit may be an input/output circuit or a communication interface. The processing unit is a processor, a microprocessor, or an integrated circuit integrated on the chip. This is not limited herein.

FIG. 21 is a block diagram of a communication apparatus 300 according to an embodiment of this application. The apparatus 300 includes a processor 310 and a transceiver 320. The processor 310 and the transceiver 320 communicate with each other through an internal connection path, and the processor 310 is configured to execute instructions, to control the transceiver 320 to send a signal and/or receive a signal.

Optionally, the apparatus 300 may further include a memory 330. The memory 330 communicates with the processor 310 and the transceiver 320 through an internal connection path. The memory 330 is configured to store instructions, and the processor 310 may execute the instructions stored in the memory 330. In a possible implementation, the apparatus 300 is configured to implement the procedures and the steps corresponding to the co-sensing initiator in the foregoing method embodiments. In another possible implementation, the apparatus 300 is configured to implement the procedures and the steps corresponding to the co-sensing responder in the foregoing method embodiments.

It should be understood that the apparatus 300 may be the co-sensing initiator or the co-sensing responder in the foregoing embodiments, or may be a chip or a chip system. Correspondingly, the transceiver 320 may be a transceiver circuit of the chip. This is not limited herein. The apparatus 300 may be configured to perform the steps and/or the procedures corresponding to the co-sensing initiator or the co-sensing responder in the foregoing method embodiments. Optionally, the memory 330 may include a read-only memory and a random access memory, and provides instructions and data for the processor. A part of the memory may further include a non-volatile random access memory. For example, the memory may further store information about a device type. The processor 310 may be configured to execute the instructions stored in the memory. When the processor 310 executes the instructions stored in the memory, the processor 310 is configured to perform the steps and/or the procedures corresponding to the co-sensing initiator or the co-sensing responder in the foregoing method embodiments.

In an implementation process, the steps of the foregoing method may be completed through a hardware integrated logic circuit in the processor or by using instructions in a form of software. The steps in the method disclosed with reference to embodiments of this application may be directly performed and completed by a hardware processor, or may be performed and completed by a combination of hardware in the processor and a software module. The software module may be located in a mature storage medium in the art, for example, a random access memory, a flash memory, a read-only memory, a programmable read-only memory, an electrically erasable programmable memory, or a register. The storage medium is located in the memory, and the processor reads information in the memory and completes the steps of the foregoing method in combination with hardware of the processor. To avoid repetition, details are not described herein again.

It should be noted that the processor in this embodiment of this application may be an integrated circuit chip, and has a signal processing capability. In an implementation process, the steps of the foregoing method embodiments may be implemented through a hardware integrated logic circuit in the processor or by using instructions in a form of software. The processor may be a general-purpose processor, a digital signal processor (DSP), an ASIC, a field-programmable gate array (FPGA) or another programmable logic device, a discrete gate or a transistor logic device, or a discrete hardware component. The processor in this embodiment of this application may implement or perform the methods, the steps, and the logical block diagrams that are disclosed in embodiments of this application. The general-purpose processor may be a microprocessor, and the processor may alternatively be any conventional processor or the like. The steps in the method disclosed with reference to embodiments of this application may be directly performed and completed by a hardware decoding processor, or may be performed and completed by a combination of hardware in the decoding processor and a software module. The software module may be located in a mature storage medium in the art, for example, a random access memory, a flash memory, a read-only memory, a programmable read-only memory, an electrically erasable programmable memory, or a register. The storage medium is located in the memory, and the processor reads information in the memory and completes the steps of the foregoing method in combination with hardware of the processor.

It may be understood that the memory in this embodiment of this application may be a volatile memory or a non-volatile memory, or may include the volatile memory and the non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), and is used as an external cache. By way of example and not limitation, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM). It should be noted that the memory in the system and the method described in this specification is intended to include but is not limited to these memories and any memory of another appropriate type.

It should be noted that, when the processor is a general-purpose processor, a DSP, an ASIC, an FPGA or another programmable logic device, a discrete gate or a transistor logic device, or a discrete hardware component, the memory (a storage module) may be integrated into the processor.

In addition, this application further provides a computer-readable storage medium. The computer-readable storage medium stores computer instructions. When the computer instructions are run on a computer, the operations and/or the procedures performed by the co-sensing initiator or the co-sensing responder in the method embodiments of this application are performed.

This application further provides a computer program product. The computer program product includes computer program code or instructions. When the computer program code or the instructions are run on a computer, the operations and/or the procedures performed by the co-sensing initiator or the co-sensing responder in the method embodiments of this application are performed.

In addition, this application further provides a chip. The chip includes a processor. A memory configured to store a computer program is disposed independently of the chip. The processor is configured to execute the computer program stored in the memory, so that the operations and/or processing performed by the co-sensing initiator or the co-sensing responder in any method embodiment are/is performed.

Further, the chip may further include a communication interface. The communication interface may be an input/output interface, an interface circuit, or the like. Further, the chip may include a memory.

In addition, this application further provides a communication system, including the co-sensing initiator and the co-sensing responder in embodiments of this application.

It should be further noted that the memory described in this specification is intended to include but is not limited to these memories and any memory of another appropriate type.

A person of ordinary skill in the art may be aware that units and algorithm steps in the examples described with reference to embodiments disclosed in this specification can be implemented by electronic hardware or a combination of computer software and the electronic hardware. Whether these functions are performed by hardware or software depends on particular applications and design constraints of the technical solutions. A person skilled in the art may use different methods to implement the described functions for each particular application, but it should not be considered that the implementation goes beyond the scope of this application. It may be clearly understood by a person skilled in the art that, for convenience and brevity of description, for a detailed working process of the foregoing system, apparatus, and unit, refer to a corresponding process in the foregoing method embodiment. Details are not described herein again. In the several embodiments provided in this application, it should be understood that the disclosed system, apparatus, and method may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms. The units described as separate parts may or may not be physically separate, and parts displayed as units may or may not be physical units, and, for example, may be located at one location, or may be distributed on a plurality of network units. Some or all of the units may be selected based on actual requirements, to achieve the objectives of the solutions in embodiments. In addition, functional units in embodiments of this application may be integrated into one processing unit, or each of the units may exist alone physically, or two or more units may be integrated into one unit.

The functions may be stored in a computer-readable storage medium when the functions are implemented in a form of a software functional unit and sold or used as an independent product. Based on such an understanding, the technical solutions in this application essentially, or the part contributing to the conventional technology, or a part of the technical solutions may be implemented in a form of a software product. The computer software product is stored in a storage medium, and includes several instructions for indicating a computing device (which may be a personal computer, a server, or a network device) to perform all or a part of the steps of the methods described in embodiments of this application. The foregoing storage medium includes any medium that can store program code, for example, a USB flash drive, a removable hard disk, a ROM, a RAM, a magnetic disk, or an optical disc.

It should be understood that an “embodiment” mentioned throughout this specification means that particular features, structures, or characteristics related to this embodiment are included in at least one embodiment of this application. Therefore, embodiments in the entire specification do not necessarily refer to a same embodiment. In addition, these particular features, structures, or characteristics may be combined in one or more embodiments in any appropriate manner.

It should be further understood that ordinal numbers such as “first” and “second” in embodiments of this application are used to distinguish between a plurality of objects, but are not intended to limit sizes, content, a sequence, a time sequence, priorities, importance of the plurality of objects, or the like.

It should be further understood that, in this application, both “when” and “if” mean that a network element performs corresponding processing in an objective situation, but do not constitute a limitation on time, do not require that the network element certainly has a determining action during implementation, and do not mean another limitation either.

It should be further understood that, in this application, “at least one” means one or more, and “a plurality of” means two or more. “At least one of items (pieces)” or a similar expression thereof means one item (piece) or a plurality of items (pieces), namely, any combination of these items, including a single item (piece) or any combination of a plurality of items (pieces). For example, at least one of a, b, or c may indicate a, b, c, a and b, a and c, b and c, or a, b, and c.

It should be further understood that, unless otherwise specified, an expression similar to “an item includes one or more of the following: A, B, and C” in this application generally means that the item may be any one of the following: A: B: C: A and B: A and C: B and C: A, B, and C: A and A: A, A, and A: A, A, and B: A, A, and C: A, B, and B: A, C, and C: B and B: B, B, and B: B, B, and C: C and C: C, C, and C; and another combination of A, B and C. The foregoing uses three elements A, B, and C as an example to describe an optional case of the item. When an expression is “an item includes at least one of the following: A, B . . . , and X”, in other words, more elements are included in the expression, a case to which the item is applicable may also be obtained according to the foregoing rule.

It should be further understood that the term “and/or” in this specification describes only an association relationship between associated objects, and indicates that three relationships may exist. For example, A and/or B may indicate the following cases: A exists alone, both A and B are included, and B exists alone, where A and B may be singular or plural. The character “/” generally indicates an “or” relationship between associated objects. For example, A/B indicates A or B.

It should be further understood that, in embodiments of this application, “B corresponding to A” indicates that B is associated with A, and B may be determined based on A. However, it should be further understood that determining B based on A does not mean that B is determined based only on A. B may alternatively be determined based on A and/or other information.

The foregoing descriptions are merely example implementations of this application, but are not intended to limit the protection scope of this application. Any variation or replacement readily figured out by a person skilled in the art in the technical scope disclosed in this application shall fall within the protection scope of this application. Therefore, the protection scope of this application shall be subject to the protection scope of the claims.

1. A processing apparatus, comprising:
a processor, wherein the processing apparatus is a first access point (AP), and when the processor executes a computer program stored in a memory, the processing apparatus is caused to:
separately send, to N access points (APs), first request frames corresponding to the N APs, wherein the first request frames are used by the N APs to initiate a multi-AP joint sensing by proxy request, and N is a positive integer; and
separately receive, from the N APs, first response frames corresponding to the N APs, wherein the first response frames indicate the multi-AP joint sensing by proxy request is accepted.

2. The processing apparatus according to claim 1, wherein the first request frames comprise first information, the first information indicates the first request frames are used by the N APs to initiate multi-AP joint sensing by proxy, and the first information is carried in a public action/protected dual of public action field in the first request frames.

3. The processing apparatus according to claim 1, wherein at least one first request frame of the first request frames comprises second information, the second information comprises a parameter for a second AP of the N APs to perform multi-AP joint sensing by proxy.

4. The processing apparatus according to claim 3, wherein the parameter for the second AP to perform the multi-AP joint sensing by proxy comprises one or more of a multi-AP joint sensing expiration time, a multi-AP coordinated transmission model, a trigger-based sounding phase model, a number of sensing responder stations, or whether the number of sensing responder is mandatory.

5. The processing apparatus according to claim 1, wherein the first response frames comprise third information, the third information indicates the first response frame is in response to the multi-AP joint sensing by proxy request initiated by the first AP, and the third information is carried in a public action/protected dual of public action field in the first response frame.

6. The processing apparatus according to claim 1, wherein the processing apparatus is further caused to:
receive a second request frame from a first station (STA), wherein the second request frame is used by the first STA to initiate the multi-AP joint sensing by proxy request; and
send a second response frame to the first STA, wherein the second response frame indicates the multi-AP joint sensing by proxy request is accepted.

7. The processing apparatus according to claim 6, wherein the second request frame comprises fourth information, the fourth information indicates the second request frame is used by the first STA to initiate the multi-AP joint sensing by proxy, and the fourth information is carried in a public action/protected dual of public action in the second request frame.

8. The processing apparatus according to claim 6, wherein the second request frame comprises fifth information, and the fifth information comprises a parameter for the multi-AP joint sensing by proxy.

9. The processing apparatus according to claim 8, wherein the parameter for the multi-AP joint sensing by proxy comprises one or more of a multi-AP joint sensing expiration time, a multi-AP coordinated transmission model, a trigger-based sounding phase model, a number of APs for establishing multi-AP joint sensing by proxy, whether the number of APs is mandatory, whether an AP that receives the second request frame needs to perform sensing measurement, a number of sensing responder STAs, whether the number of sensing responder STAs is mandatory, whether to recommend, to the AP that receives the second request frame, an AP for performing joint sensing by proxy, whether to provide different multi-AP joint sensing by proxy parameters for the recommended AP, or whether the first STA needs to participate in sensing measurement.

10. The processing apparatus according to claim 9, wherein in response to the fifth information indicating to provide different sensing parameters for the recommended AP, the second request frame comprises sixth information, and the sixth information comprises a sensing parameter allocated to the recommended AP.

11. A processing apparatus, comprising:
a processor, wherein the processing apparatus is a second access point (AP), and when the processor executes a computer program stored in a memory, the processing apparatus is caused to:
receive a first request frame from a first AP, wherein the first request frame is used to initiate a multi-AP joint sensing by proxy request, the second AP is one AP of N APs requested by the first AP for multi-AP joint sensing by proxy, and N is an integer; and
send a first response frame to the first AP, wherein the first response frame indicates the multi-AP joint sensing by proxy request is accepted.

12. The processing apparatus according to claim 11, wherein the first request frame comprises first information, the first information indicates the first request frame is used by the second AP to initiate multi-AP joint sensing by proxy, and the first information is carried in a public action/protected dual of public action field in the first request frame.

13. The processing apparatus according to claim 11, wherein the first request frame comprises second information, and the second information comprises a parameter for the second AP to perform multi-AP joint sensing by proxy.

14. The processing apparatus according to claim 13, wherein the parameter for the second AP to perform the multi-AP joint sensing by proxy comprises one or more of a multi-AP joint sensing expiration time, a multi-AP coordinated transmission model, a trigger-based sounding phase model, a number of sensing responder stations, or whether the number of sensing responder is mandatory.

15. The processing apparatus according to claim 11, wherein the first response frame comprises third information, the third information indicates the first response frame is in response to the multi-AP joint sensing by proxy request initiated by the first AP, and the third information is carried in a public action/protected dual of public action field in the first response frame.

16. The processing apparatus according to claim 11, wherein the processing apparatus is further caused to:
perform multi-AP joint sensing measurement under triggering of the first AP.

17. The processing apparatus according to claim 16, wherein the processing apparatus is further caused to:
receive a third polling trigger frame from the first AP, wherein the third polling trigger frame is used to trigger the second AP to perform the multi-AP joint sensing measurement; and
send a third polling acknowledgment frame to the first AP.

18. The processing apparatus according to claim 16, wherein the processing apparatus is further caused to:
receive a second polling trigger frame from the first AP, wherein the second polling trigger frame is used to trigger the N APs to respectively perform the multi-AP joint sensing measurement based on respective corresponding sensing measurement start times and durations; and
send a second polling acknowledgment frame to the first AP, wherein the second polling acknowledgment frame indicates the second AP confirms to perform the multi-AP joint sensing measurement based on a corresponding sensing measurement start time and a corresponding duration.

19. The processing apparatus according to claim 18, wherein the second polling trigger frame comprises eighth information, and the eighth information comprises the start times and the durations for the N APs to perform the multi-AP joint sensing measurement.

20. The processing apparatus according to claim 17, wherein fourteenth information in the third polling trigger frame is used to trigger the second AP to perform the multi-AP joint sensing measurement, and the fourteenth information is carried in a sensing trigger subtype field in a trigger dependent common information field in the third polling trigger frame.
